(19) United States
(12) Patent Application Publication
(10) Pub. No.: US 2023/0408267 A1
(43) Pub. Date: Dec. 21, 2023

(54) INFORMATION PROCESSING SYSTEM, INFORMATION PROCESSING METHOD, AND INFORMATION PROCESSING PROGRAM

(71) Applicant: SONY GROUP CORPORATION, TOKYO (JP)

(72) Inventors: YUKI TANAIKE, Tokyo (JP); KAZUAKI TAKAHASHI, Tokyo (JP); MASANE KAWASAKI, Tokyo (JP)

(21) Appl. No.: 18/249,955

(22) PCT Filed: Oct. 4, 2021
(86) PCT No.: PCT/JP2021/036594

§ 371 Date: Apr. 20, 2023

(30) Foreign Application Priority Data
Oct. 29, 2020 (JP) 2020-181372

(51) Int. Cl. G01C 21/34; G01C 21/32; G01C 21/36

(52) U.S. Cl. CPC G01C 21/3415; G01C 21/362; G01C 21/32

(57) ABSTRACT

[Object] To provide an information processing system that enables a passenger to give an appropriate instruction about a route to a driver.

[Solving Means] An information processing system includes: a first information processing terminal that includes a first display apparatus and is configured to display on the first display apparatus a first map and a first route from a current location to a destination in a superimposed manner, the first map being created using a first creation system; a second information processing terminal that is capable of communicating with the first information processing terminal, includes a second display apparatus, and is configured to display on the second display apparatus a second map and a second route from the current location to the destination in a superimposed manner, the second map being created by a second creation system; an integrated map synchronization unit that displays an integrated map, synchronized between the first display apparatus and the second display apparatus, the integrated map being a map obtained by integrating the first map and the second map; and an integrated route synchronization unit that displays an integrated route, synchronized between the first display apparatus and the second display apparatus, the integrated route being a route obtained by integrating the first route and the second route.

### TECHNICAL FIELD

The present disclosure relates to an information processing system including an information processing terminal used by a passenger and an information processing terminal used by a driver. The present disclosure relates to an information processing method and a synchronization program to be executed by this information processing system.

### BACKGROUND ART

A travel route instructing system is known. When a passenger inputs a starting point, a stop location, a destination location, and travel conditions to a portable terminal, the travel route instructing system instructs a driver of a route appropriate to the conditions (Patent Literature 1).

### CITATION LIST

### Patent Literature

Patent Literature 1: Japanese Patent Application Laid-open No. 2003-346291

### DISCLOSURE OF INVENTION

### Technical Problem

In particular, in a case where the system does not output a route as the passenger desires, it may be difficult for the passenger to give an appropriate instruction about the route directly to a taxi driver or ride-sharing driver. Therefore, it is desirable to provide a more user-friendly system.

### Solution to Problem

An information processing system according to an embodiment of the present disclosure includes:
a first information processing terminal that includes a first display apparatus and is configured to display on the first display apparatus a first map and a first route from a current location to a destination in a superimposed manner, the first map being created using a first creation system;
a second information processing terminal that is capable of communicating with the first information processing terminal, includes a second display apparatus, and is configured to display on the second display apparatus a second map and a second route from the current location to the destination in a superimposed manner, the second map being created by a second creation system;
an integrated map synchronization unit that displays an integrated map, synchronized between the first display apparatus and the second display apparatus, the integrated map being a map obtained by integrating the first map and the second map; and
an integrated route synchronization unit that displays an integrated route, synchronized between the first display apparatus and the second display apparatus, the integrated route being a route obtained by integrating the first route and the second route.

In accordance with the present embodiment, in a case where the first map created by the first information processing terminal is different from the second map created by the second information processing terminal, a common integrated map is displayed on the first information processing terminal and the second information processing terminal. In other words, the first information processing terminal and the second information processing terminal use a common integrated map on a road-by-road basis. Therefore, the first information processing terminal and the second information processing terminal can reliably share information on a road-by-road basis, preventing the possibility that one map has a narrow path that the other map does not have. In accordance with the present embodiment, in a case where the first route created by the first information processing terminal is different from the second route created by the second information processing terminal, a common integrated route is displayed on the first information processing terminal and the second information processing terminal. In other words, the first information processing terminal and the second information processing terminal use a common integrated route on a road-by-road basis. Therefore, it is easy to give an instruction about a desired route on a road-by-road basis.

The first information processing terminal includes
an operation apparatus, and
a modified route generation unit that operates the integrated route displayed on the first display apparatus via the operation apparatus, thereby creating a modified route, the modified route being a route obtained by modifying the integrated route, further including
a server apparatus that is capable of communicating with the first information processing terminal and the second information processing terminal and has a modified route synchronization unit that displays the modified route, synchronized between the first display apparatus and the second display apparatus.

In accordance with the present embodiment, the first information processing terminal and the second information processing terminal use a common integrated map on a road-by-road basis. Therefore, the modified route created using the first information processing terminal can be reliably displayed on the second information processing terminal, preventing the possibility that one map has a narrow path that the other map does not have, for example.

The modified route synchronization unit of the server apparatus changes the modified route created by the modified route generation unit of the first information processing terminal on the basis of additional information and displays the changed modified route, synchronized between the first display apparatus and the second display apparatus, the first creation system and the second creation system not having the additional information.

In accordance with the present embodiment, the server apparatus changes the modified route on the basis of the additional information rather than employing the modified route as it is by using the first information processing terminal. This can present a more suitable modified route.

The integrated map is the first map or the second map created using either one of the first creation system and the second creation system, which is selected on the basis of an attribute.

In accordance with the present embodiment, the creation system selected on the basis of the attribute creates the integrated map. Therefore, the first information processing terminal and the second information processing terminal can share a more advanced integrated map.

The integrated map is created by adding additional information to the integrated map, the first creation system and the second creation system not having the additional information.

In accordance with the present embodiment, the first map or the second map is changed on the basis of the additional information rather than employing the first map or the second map as the integrated map as it is. Accordingly, the first information processing terminal and the second information processing terminal can share the additional information. Therefore, the first information processing terminal and the second information processing terminal can easily communicate with each other, for example, easily change the route on the basis of common recognition.

The first information processing terminal and the second information processing terminal each include the integrated map synchronization unit, and
the integrated map synchronization unit of either one of the first information processing terminal and the second information processing terminal creates the integrated map and sends the created integrated map to another one of the first information processing terminal and the second information processing terminal.

In accordance with the present embodiment, the integrated map created by the one information processing terminal can be directly synchronized (mirrored) with the other information processing terminal.

The integrated map is created by combining the first map and the second map and is different from both the first map and the second map.

In accordance with the present embodiment, the first map and the second map are combined rather than employing the first map or the second map as the integrated map as it is. Accordingly, the first information processing terminal and the second information processing terminal can share an integrated map including higher-level information. Moreover, since the integrated map includes both elements of the first map and the second map, the integrated map includes familiar map elements. It is user-friendly.

The integrated map is created by adding additional information to the integrated map, the first creation system and the second creation system not having the additional information.

In accordance with the present embodiment, the integrated map obtained by combining the first map and the second map is changed on the basis of the additional information rather than employing it as the integrated map as it is. Accordingly, the first information processing terminal and the second information processing terminal can share the additional information. Therefore, the first information processing terminal and the second information processing terminal can easily communicate with each other, for example, easily change the route on the basis of common recognition.

The information processing system further includes
a server apparatus that is capable of communicating with the first information processing terminal and the second information processing terminal and has the integrated map synchronization unit, in which
the integrated map synchronization unit creates the integrated map and sends the created integrated map to the first information processing terminal and the second information processing terminal.

In accordance with the present embodiment, the integrated map created by the one information processing terminal can be synchronized (mirrored) with the other information processing terminal via the server apparatus.

The integrated route is the first route or the second route created using either one of the first creation system and the second creation system, which is selected on the basis of an attribute.

In accordance with the present embodiment, the selected creation system creates the integrated route on the basis of the attribute. Therefore, the first map and the second map can share a more appropriate (e.g., faster) integrated route.

The integrated route is created by changing the integrated route on the basis of additional information, which the first creation system and the second creation system do not have.

In accordance with the present embodiment, the first route or the second route is changed on the basis of the additional information rather than employing it as the integrated route as it is. Accordingly, the first information processing terminal and the second information processing terminal can share the additional information. Therefore, the first information processing terminal and the second information processing terminal can easily communicate with each other, for example, easily change the route on the basis of common recognition.

The first information processing terminal and the second information processing terminal each include the integrated route synchronization unit, and
the integrated route synchronization unit of either one of the first information processing terminal and the second information processing terminal creates the integrated route and sends the created integrated route to another one of the first information processing terminal and the second information processing terminal.

In accordance with the present embodiment, the integrated route created by the one information processing terminal can be directly synchronized (mirrored) with the other information processing terminal.

The information processing system further includes
a server apparatus that is capable of communicating with the first information processing terminal and the second information processing terminal and has the integrated route synchronization unit, in which
the integrated route synchronization unit creates the integrated route and sends the created integrated route to the first information processing terminal and the second information processing terminal.

In accordance with the present embodiment, the integrated route created by the one information processing terminal can be synchronized (mirrored) with the other information processing terminal via the server apparatus.

The information processing system further includes
a route deviation notification unit that determines that a current location of the first information processing terminal or the second information processing terminal has deviated from the integrated route and outputs a notification indicating the deviation to the first information processing terminal.

In accordance with the present embodiment, it is possible to know the deviation of the route and the reason by using the first information processing terminal.

The first information processing terminal is used by a passenger who travels from the current location to the destination by the vehicle, and
the second information processing terminal is used by a driver of the vehicle.

In accordance with the present embodiment, in a case where the first map created by the first information processing terminal used by the passenger is different from the second map created by the second information processing terminal used by the driver, a common integrated map is displayed on the first information processing terminal and the second information processing terminal. In other words, the passenger and the driver use a common integrated map on a road-by-road basis. Therefore, the passenger and the driver can reliably share information on a road-by-road basis, preventing the possibility that one map has a narrow path that the other map does not have. In accordance with the present embodiment, in a case where the first route created by the first information processing terminal used by the passenger is different from the second route created by the second information processing terminal used by the driver, a common integrated route is displayed on the first information processing terminal and the second information processing terminal. In other words, the passenger and the driver use a common integrated route on a road-by-road basis. Therefore, the passenger easily instructs the driver about a desired route on a road-by-road basis.

An information processing method according to an embodiment of the present disclosure includes:
by an information processing system including,
a first information processing terminal that includes a first display apparatus and is configured to display on the first display apparatus a first map and a first route from a current location to a destination in a superimposed manner, the first map being created using a first creation system, and
a second information processing terminal that is capable of communicating with the first information processing terminal, includes a second display apparatus, and is configured to display on the second display apparatus a second map and a second route from the current location to the destination in a superimposed manner, the second map being created by a second creation system,
displaying an integrated map, synchronized between the first display apparatus and the second display apparatus, the integrated map being a map obtained by integrating the first map and the second map; and
displaying an integrated route, synchronized between the first display apparatus and the second display apparatus, the integrated route being a route obtained by integrating the first route and the second route.

An information processing program according to an embodiment of the present disclosure causes
a processor of
a first information processing terminal that includes a first display apparatus and is configured to display on the first display apparatus a first map and a first route from a current location to a destination in a superimposed manner, the first map being created using a first creation system, or
a second information processing terminal that is capable of communicating with the first information processing terminal, includes a second display apparatus, and is configured to display on the second display apparatus a second map and a second route from the current location to the destination in a superimposed manner, the second map being created by a second creation system, to operate to:
display an integrated map, synchronized between the first display apparatus and the second display apparatus, the integrated map being a map obtained by integrating the first map and the second map; and
display an integrated route, synchronized between the first display apparatus and the second display apparatus, the integrated route being a route obtained by integrating the first route and the second route.

### Advantageous Effects of Invention

In accordance with the present disclosure, it is possible to provide a more user-friendly system in order for the passenger to give an appropriate route instruction to a taxi driver or ride-sharing driver.

It should be noted that the effects described here are not necessarily limitative and any effect described in the present disclosure may be provided.

### BRIEF DESCRIPTION OF DRAWINGS

FIG. 1 A diagram showing an information processing system according to a first embodiment of the present disclosure.

FIG. 2 A diagram showing hardware configurations of a first information processing terminal.

FIG. 3 A diagram showing hardware configurations of a second information processing terminal.

FIG. 4 A diagram showing functional configurations of the information processing system.

FIG. 5 A diagram showing an operation flow of the information processing system.

FIG. 6 A diagram showing an information processing system according to a second embodiment of the present disclosure.

FIG. 7 A diagram showing hardware configurations of a server apparatus.

FIG. 8 A diagram showing functional configurations of the information processing system.

FIG. 9 A diagram showing an operation flow of the information processing system.

FIG. 10 A diagram showing functional configurations of an information processing system according to a third embodiment of the present disclosure.

FIG. 11 A diagram showing an operation flow of the information processing system.

FIG. 12 A diagram showing functional configurations of an information processing system according to a fourth embodiment of the present disclosure.

FIG. 13 A diagram showing an operation flow of the information processing system.

FIG. 14 A diagram showing functional configurations of an information processing system according to a fifth embodiment of the present disclosure.

FIG. 15 A diagram showing an operation flow of the information processing system.

FIG. 16 An example of a first map.

FIG. 17 An example of a second map.

FIG. 18 A diagram showing an example of an integrated map.

FIG. 19 A block diagram showing a configuration example of a taxi dispatch system according to each embodiment of an example of a previous phase.

FIG. 20 A flowchart of dispatch control processing by the taxi dispatch system.

### MODE(S) FOR CARRYING OUT THE INVENTION

Hereinafter, embodiments of the present disclosure will be described with reference to the drawings.

### I. First Embodiment

1. Outline of Information Processing System

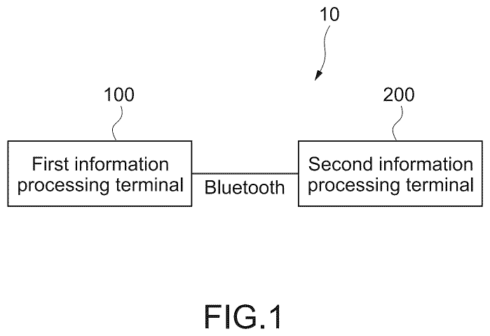

FIG. 1 shows an information processing system according to a first embodiment of the present disclosure.

An information processing system 10 includes a first information processing terminal 100 and a second information processing terminal 200.

The first information processing terminal 100 is a terminal apparatus used by a passenger of a taxi or ride-sharing vehicle. Specifically, the first information processing terminal 100 is a smartphone, a tablet computer, a personal computer, or the like owned by the passenger. Alternatively, the first information processing terminal 100 may be a smartphone, a tablet computer, or the like attached to the vehicle (e.g., mounted on the back of a front seat). Typically, the first information processing terminal 100 has a touch panel.

The second information processing terminal 200 is a terminal apparatus used by a taxi driver or ride-sharing vehicle driver. Specifically, the second information processing terminal 200 is a smartphone, a tablet computer, or the like used by the driver for tasks. Alternatively, the second information processing terminal 200 may be a vehicle-mounted car navigation system or the like.

The first information processing terminal 100 and the second information processing terminal 200 are capable of communicating with each other. The first information processing terminal 100 and the second information processing terminal 200 are connected to each other typically via near-field communication such as Bluetooth (registered trademark). A situation where the first information processing terminal 100 and the second information processing terminal 200 are connected to each other via the near-field communication is specifically a situation where the passenger who uses the first information processing terminal 100 is in the vehicle of the driver who uses the second information processing terminal 200 as a premise. In other words, the first information processing terminal 100 and the second information processing terminal 200 are located within a connection area of the near-field communication. It should be noted that the first information processing terminal 100 and the second information processing terminal 200 may be capable of communicating with each other via a network such as the Internet.

The present embodiment has the assumption that the passenger who uses the first information processing terminal 100 does not drive the vehicle. As a typical example, as described above, the first information processing terminal 100 is the terminal apparatus used by the passenger of the taxi or ride-sharing vehicle and the second information processing terminal 200 is the terminal apparatus used by the driver. As another example, the first information processing terminal 100 may be a terminal apparatus used by a passenger of an automated-driving vehicle and the second information processing terminal 200 may be a car navigation system or the like mounted on the automated-driving vehicle.

2. Hardware Configurations of First Information Processing Terminal

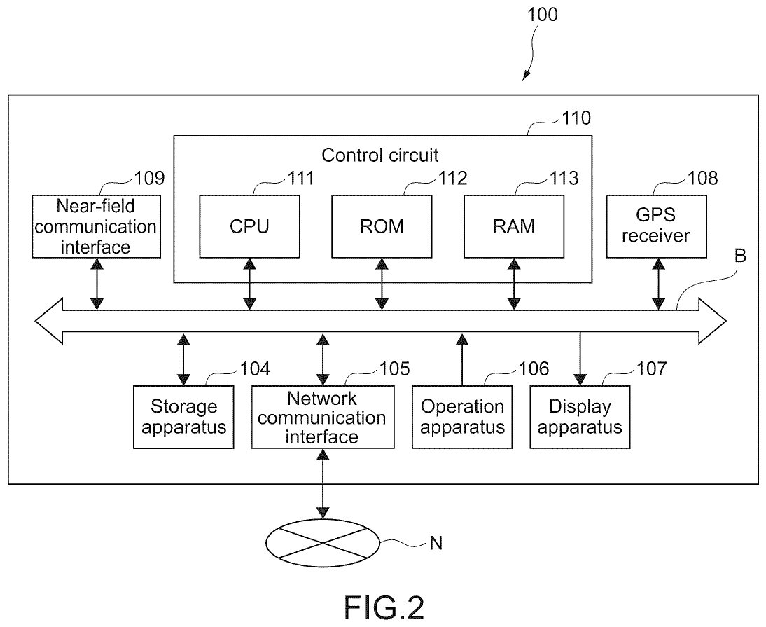

FIG. 2 shows hardware configurations of the first information processing terminal.

The first information processing terminal 100 has a control circuit 110, a storage apparatus 104, a network communication interface 105, an operation apparatus 106, a display apparatus 107, a GPS receiver 108, a near-field communication interface 109, and a bus B for connecting them to one another.

The control circuit 110 is a system-on-a-chip (SoC) including a central processing unit (CPU) 111 (processor), a read only memory (ROM) 112, and a random access memory (RAM) 113. The CPU 111 loads an information processing program stored in the ROM 112 to the RAM 113 and executes it. The ROM 112 permanently stores programs, data, and the like to be executed by the CPU 111. The ROM 112 is an example of a non-transitory computer-readable recording medium. The control circuit 110 further includes dedicated hardware circuit, graphics processing unit (GPU), and the like (not shown).

The storage apparatus 114 includes a high-capacity nonvolatile recording medium such as a solid state drive (SSD).

The network communication interface 115 is an interface for connecting to a network N such as the Internet.

The operation apparatus 116 includes a touch panel, various switches, and the like. The operation apparatus 116 detects an operation from the user and outputs it to the CPU 111. The operation apparatus 116 is a type of input apparatus. In addition, an audio input apparatus such as a microphone may be provided as the input apparatus.

The display apparatus 107 (first display apparatus) includes an LCD, an organic EL display, or the like integrated with the touch panel. The display apparatus 107 performs arithmetic processing on the basis of the information received from the control circuit 110 and displays the generated image signal on the screen. The display apparatus 107 is a type of output apparatus. In addition, an audio output apparatus such as a loudspeaker may be provided as the output apparatus.

The GPS receiver 118 receives GPS information that is position information.

The near-field communication interface 119 is an interface for performing near-field communication such as Bluetooth (registered trademark).

3. Hardware Configurations of Second Information Processing Terminal

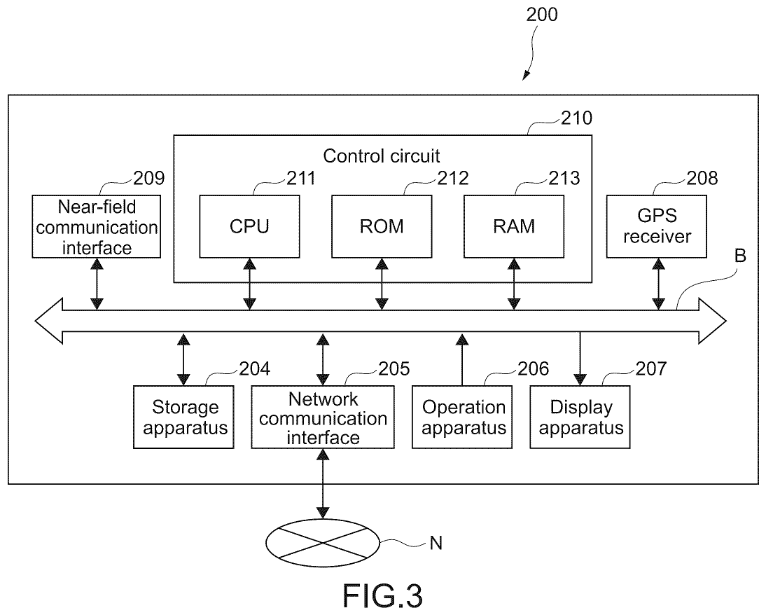

FIG. 3 shows hardware configurations of the second information processing terminal.

The second information processing terminal 200 has a control circuit 210, a storage apparatus 214, a network communication interface 215, an operation apparatus 216, a display apparatus 207, a GPS receiver 218, a near-field communication interface 219, and a bus B for connecting them to one another.

The control circuit 210 is an SoC including a CPU 211 (processor), a ROM 212, and a RAM 213. The CPU 211 loads an information processing program stored in the ROM 212 to the RAM 213 and executes it. The ROM 212 permanently stores programs, data, and the like to be executed by the CPU 211. The ROM 212 is an example of a non-transitory computer-readable recording medium. The control circuit 210 further includes dedicated hardware circuit, GPU, and the like (not shown).

The storage apparatus 214 includes a high-capacity nonvolatile recording medium such as an SSD.

The network communication interface 215 is an interface for connecting to a network N such as the Internet.

The operation apparatus 216 includes a touch panel, various switches, and the like. The operation apparatus 216 detects an operation from the user and outputs it to the CPU 211. The operation apparatus 216 is a type of input apparatus. In addition, an audio input apparatus such as a microphone may be provided as the input apparatus.

The display apparatus 207 (second display apparatus) includes an LCD, an organic EL display, or the like integrated with the touch panel. The display apparatus 207 performs arithmetic processing on the basis of the information received from the control circuit 210 and displays the generated image signal on the screen. The display apparatus 207 is a type of output apparatus. In addition, an audio output apparatus such as a loudspeaker may be provided as the output apparatus.

The GPS receiver 218 receives GPS information that is position information.

The near-field communication interface 219 is an interface for performing near-field communication such as Bluetooth (registered trademark).

4. Functional Configurations of Information Processing System

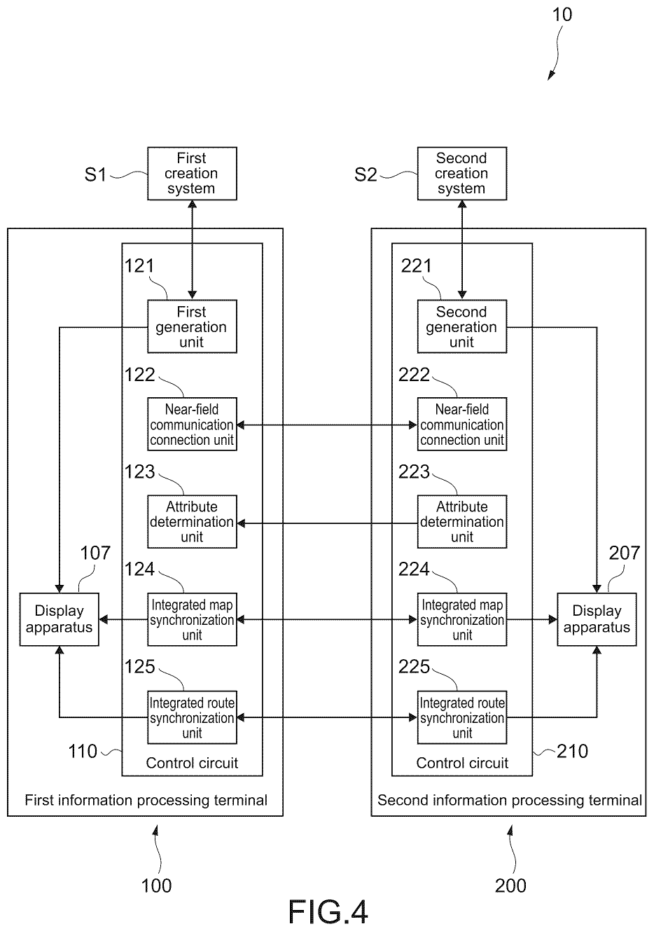

FIG. 4 shows functional configurations of the information processing system.

In the control circuit 110 of the first information processing terminal 100, the CPU 111 loads the information processing program stored in the ROM 112 to the RAM 113 and executes it. In this manner, the CPU 111 operates as a first generation unit 121, a near-field communication connection unit 122, an attribute determination unit 123, an integrated map synchronization unit 124, and an integrated route synchronization unit 125.

In the control circuit 210 of the second information processing terminal 200, the CPU 211 loads the information processing program stored in the ROM 212 to the RAM 213 and executes it. In this manner, the CPU 211 operates as a second generation unit 221, a near-field communication connection unit 222, an attribute determination unit 223, an integrated map synchronization unit 224, and an integrated route synchronization unit 225.

5. Operation Flow of Information Processing System

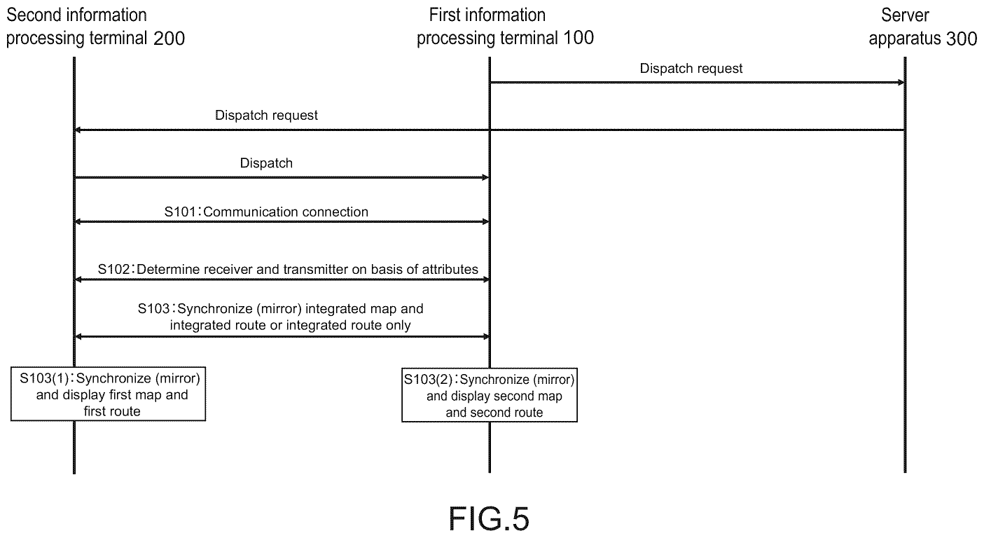

FIG. 5 shows an operation flow of the information processing system.

An example in a phase before executing an operation flow according to the present embodiment (information processing method according to the present embodiment) will be described. The passenger requests to dispatch a taxi or shared car by using the first information processing terminal 100. The server apparatus determines a vehicle to dispatch. The server apparatus requests the second information processing terminal 200 used by a driver of the vehicle to dispatch the vehicle (directly or via a system of a taxi company or the like). The vehicle arrives at a current location (starting point) of the passenger. At this time, the first information processing terminal 100 and the second information processing terminal 200 have position information of the current location (starting point) that is GPS information. The first information processing terminal 100 and the second information processing terminal 200 acquire the position information of the destination (e.g., by direct input or acquisition from the server apparatus) typically at a timing when it departs from the current location (starting point) (or before/after that timing). Such a dispatch flow has less direct association with the operation flow of the present embodiment. Therefore, the dispatch flow will be described and shown at the end of the present disclosure. In addition, such a dispatch flow is an example in the common previous phase for each embodiment. However, the operation flow of the present embodiment can be realized without such a dispatch flow. In other words, the present embodiment can be realized on the assumption that the first information processing terminal 100 and the second information processing terminal 200, which are different from each other, and that the passenger and the driver each use share the position information of the current location (starting point) and the position information of the destination by some method.

The first generation unit 121 of the first information processing terminal 100 communicates with a first creation system S1 via the network N. The first generation unit 121 of the first information processing terminal 100 displays on the display apparatus 107 a map (first map) created using the first creation system S1 and a route (first route) from the current location to the destination in a superimposed manner. On the other hand, the second generation unit 221 of the second information processing terminal 200 communicates with a second creation system S2 via the network N. The second generation unit 221 of the second information processing terminal 200 displays on the display apparatus 207 a map (second map) created using the second creation system S2 and a route (second route) in a superimposed manner. Attributes (suppliers, versions, etc.) of the first creation system S1 and attributes (suppliers, versions, etc.) of the second creation system S2 are typically different but may be the same. The first map and the second map are typically different but may be the same. The first route and the second route may be different or may be the same.

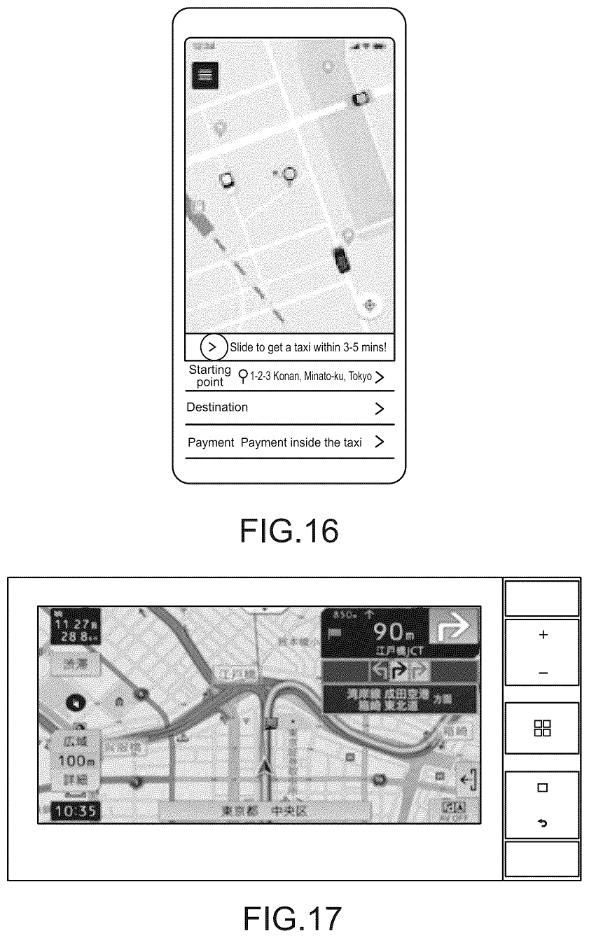

FIG. 16 shows an example of the first map. FIG. 17 shows an example of the second map different from the first map.

Hereinafter, in a case where the “map” (the first map, the second map) is simply recited, it may mean image data for displaying the map. In a case where the “route” (the first route, the second route) is simply recited, it may mean coordinate information for creating image data for displaying the route.

Step S101: The near-field communication connection unit 122 of the first information processing terminal 100 and the near-field communication connection unit 222 of the second information processing terminal 200 are paired with each other and establish near-field communication connection.

Step S102: The attribute determination unit 223 of the second information processing terminal 200 sends the attributes (supplier, version, etc.) of the second creation system S2 to the first information processing terminal 100. The attribute determination unit 123 of the first information processing terminal 100 receives the attributes of the second creation system S2 from the second information processing terminal 200. The attribute determination unit 123 compares the attributes of the first creation system S1 of the first information processing terminal 100 with the attributes of the second creation system S2 of the second information processing terminal 200. The attribute determination unit 123 selects either one of the first creation system S1 and the second creation system S2 on the basis of a comparison result of the attributes. The attribute determination unit 123 determines one of the first information processing terminal 100 and the second information processing terminal 200, which uses the selected one of the first creation system S1 and the second creation system S2, as a sender terminal and the other as a receiver terminal. For example, the attribute determination unit 123 determines the information processing terminal that uses the creation system with the latest date of update as for different suppliers or the information processing terminal that uses the creation system of the latest version as for the same supplier as the sender terminal. The attribute determination unit 123 of the first information processing terminal 100 notifies the second information processing terminal 200 of a result of determination.

Step S103(1): A case where the first information processing terminal 100 is the sender terminal and the second information processing terminal 200 is the receiver terminal will be described. The integrated map synchronization unit 124 of the first information processing terminal 100 sends to the second information processing terminal 200 the first map (displayed on the display apparatus 107) created by the first generation unit 121 using the first creation system S1. The integrated map synchronization unit 224 of the second information processing terminal 200 receives the first map. The integrated map synchronization unit 224 displays the received first map on the display apparatus 207. Accordingly, the first map is displayed by synchronization (mirroring) between the display apparatus 107 and the display apparatus 207 as an integrated map (map obtained by integrating the first map and the second map). On the other hand, the integrated route synchronization unit 125 of the first information processing terminal 100 sends to the second information processing terminal 200 the first route (displayed on the display apparatus 107) created by the first generation unit 121 using the first creation system S1. The integrated route synchronization unit 225 of the second information processing terminal 200 receives the first route. The integrated route synchronization unit 225 displays on the display apparatus 207 the received first route, superimposed on the first map. Accordingly, the first route is displayed by synchronization (mirroring) between the display apparatus 107 and the display apparatus 207 as an integrated route (route obtained by integrating the first route and the second route).

Step S103(2): A case where the second information processing terminal 200 is the sender terminal and the first information processing terminal 100 is the receiver terminal will be described. The integrated map synchronization unit 224 of the second information processing terminal 200 sends to the first information processing terminal 100 the second map (displayed on the display apparatus 207) created by the second generation unit 221 using the second creation system S2. The integrated map synchronization unit 124 of the first information processing terminal 100 receives the second map. The integrated map synchronization unit 124 displays the received second map on the display apparatus 107. Accordingly, the second map is displayed by synchronization (mirroring) between the display apparatus 107 and the display apparatus 207 as an integrated map (map obtained by integrating the first map and the second map). On the other hand, the integrated route synchronization unit 225 of the second information processing terminal 200 sends to the first information processing terminal 100 the second route (displayed on the display apparatus 207) created by the second generation unit 221 using the second creation system S2. The integrated route synchronization unit 125 of the first information processing terminal 100 receives the second route. The integrated route synchronization unit 125 displays on the display apparatus 107 the received second route, superimposed on the second map. Accordingly, the second route is displayed by synchronization (mirroring) between the display apparatus 107 and the display apparatus 207 as an integrated route (route obtained by integrating the first route and the second route).

As a modified example, only the route may be synchronized without synchronizing the map.

### II. Second Embodiment

Hereinafter, descriptions and illustrations of configurations and operations similar to configurations and operations already described will be omitted and different points will be mainly described.

1. Outline of Information Processing System

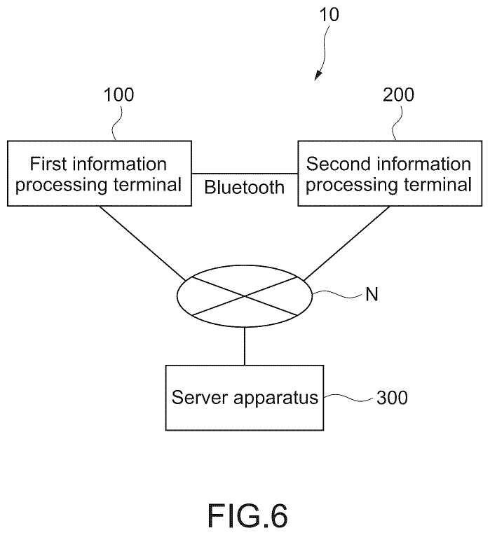

FIG. 6 shows an information processing system according to a second embodiment of the present disclosure.

The information processing system 10 includes a first information processing terminal 100, a second information processing terminal 200, and a server apparatus 300.

The server apparatus 300 is capable of communicating with the first information processing terminal 100 and the second information processing terminal 200 via a network N such as the Internet. The server apparatus 300 is a server of a supplier that provides the information processing system 10.

2. Hardware Configurations of Server Apparatus

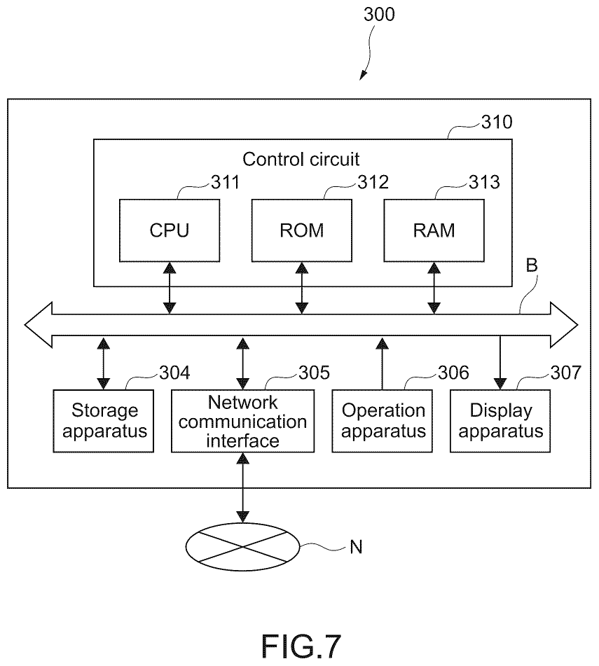

FIG. 7 shows hardware configurations of the server apparatus.

The server apparatus 300 has a control circuit 310, a storage apparatus 304, a network communication interface 305, an operation apparatus 306, a display apparatus 307, and a bus B for connecting them to one another.

The control circuit 310 includes a CPU 311, a ROM 31, and a RAM 313. The CPU 311 loads an information processing program stored in the ROM 312 to the RAM 313 and executes it. The ROM 312 permanently stores programs, data, and the like to be executed by the CPU 311. The ROM 312 is an example of a non-transitory computer-readable recording medium. The control circuit 310 further includes dedicated hardware circuit, GPU, and the like (not shown).

The storage apparatus 304 includes a high-capacity nonvolatile recording medium such as an HDD and an SSD.

The network communication interface 305 is an interface for connecting to a network N such as the Internet.

The operation apparatus 306 includes a keyboard, a mouse, a touch panel, various switches, and the like. The operation apparatus 306 detects an operation from the user and outputs it to the CPU 311. The operation apparatus 306 is a type of input apparatus. In addition, an audio input apparatus such as a microphone may be provided as the input apparatus.

The display apparatus 307 includes an LCD, an organic EL display, and the like. The display apparatus 307 performs arithmetic processing on the basis of the information received from the control circuit 310 and displays the generated image signal on the screen. The display apparatus 307 is a type of output apparatus. In addition, an audio output apparatus such as a loudspeaker may be provided as the output apparatus.

3. Functional Configurations of Information Processing System

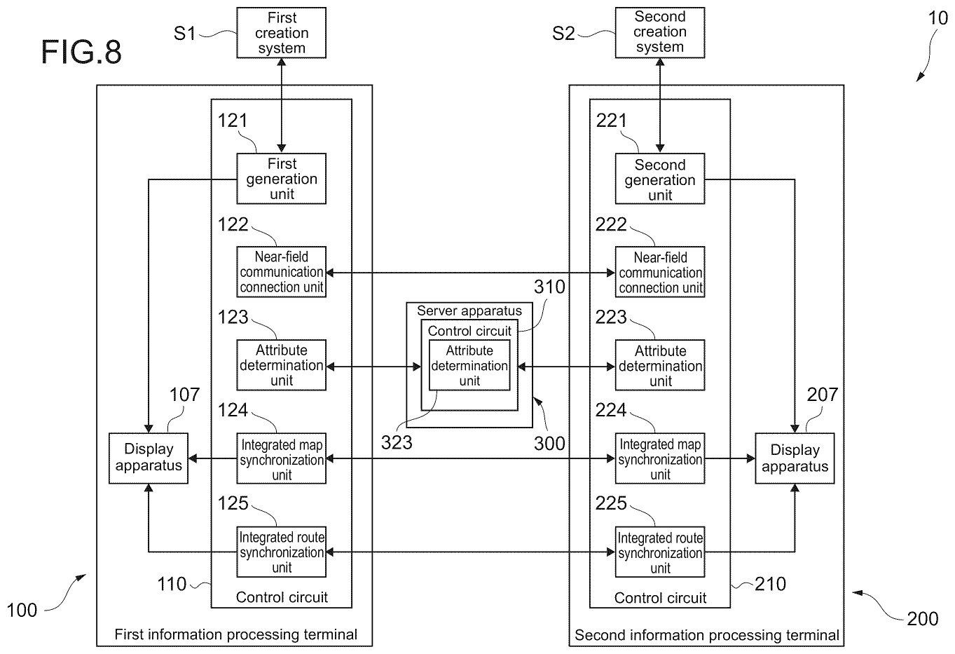

FIG. 8 shows functional configurations of the information processing system.

In the control circuit 110 of the first information processing terminal 100, the CPU 111 loads the information processing program stored in the ROM 112 to the RAM 113 and executes it. In this manner, the CPU 111 operates as a first generation unit 121, a near-field communication connection unit 122, an attribute determination unit 123, an integrated map synchronization unit 124, and an integrated route synchronization unit 125.

In the control circuit 210 of the second information processing terminal 200, the CPU 211 loads the information processing program stored in the ROM 212 to the RAM 213 and executes it. In this manner, it operates as a second generation unit 221, a near-field communication connection unit 222, an attribute determination unit 223, an integrated map synchronization unit 224, and an integrated route synchronization unit 225.

In the control circuit 310 of the server apparatus 300, the CPU 311 loads the information processing program stored in the ROM 312 to the RAM 313 and executes it. In this manner, the CPU 311 operates as an attribute determination unit 323.

4. Operation Flow of Information Processing System

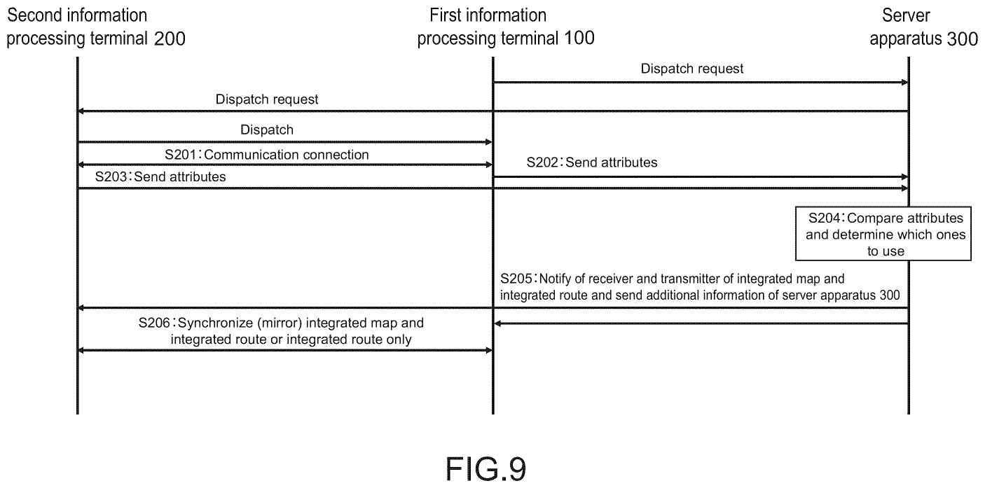

FIG. 9 shows an operation flow of the information processing system.

Step S201: The near-field communication connection unit 122 of the first information processing terminal 100 and the near-field communication connection unit 222 of the second information processing terminal 200 are paired with each other and establish near-field communication connection.

Step S202: The attribute determination unit 123 of the first information processing terminal 100 sends the attributes (supplier, version, etc.) of the first creation system S1 to the server apparatus 300. The attribute determination unit 323 of the server apparatus 300 receives the attributes of the first creation system S1 from the first information processing terminal 100.

Step S203: The attribute determination unit 223 of the second information processing terminal 200 sends the attributes (supplier, version, etc.) of the second creation system S2 to the server apparatus 300. The attribute determination unit 323 of the server apparatus 300 receives the attributes of the second creation system S2 from the second information processing terminal 200.

Step S204: The attribute determination unit 323 of the server apparatus 300 compares the attributes of the first creation system S1 of the first information processing terminal 100 with the attributes of the second creation system S2 of the second information processing terminal 200. The attribute determination unit 323 selects either one of the first creation system S1 and the second creation system S2 on the basis of a comparison result of the attributes. The attribute determination unit 323 determines one of the first information processing terminal 100 and the second information processing terminal 200, which uses the selected one of the first creation system S1 and the second creation system S2, as the sender terminal and determines the other as the receiver terminal.

Step S205: The attribute determination unit 323 of the server apparatus 300 notifies the first information processing terminal 100 and the second information processing terminal 200 of a result of determination. In addition, the attribute determination unit 323 sends additional information to the first information processing terminal 100 or the second information processing terminal 200 that is the sender terminal.

The “additional information” is information that the first creation system S1 and the second creation system S2 do not have. Examples of the additional information include change times of traffic lights, change times of railroad crossings, incident information, driving skills of the driver, vehicle dynamic data, and customer (passenger) data. On the other hand, examples of information used for creating maps and routes that the first creation system S1 has include preference information such as favorite routes and favorite places (e.g., stores) of the passenger and SNS of the passenger. Examples of information used for creating maps and routes that only the second creation system S2 has include favorite routes of the driver, taxi radio information, taxi pool waiting information, dispatch demand prediction, accident information, and taxi prohibited zones. On the other hand, examples of information that the first creation system S1 and the second creation system S2 have include traffic jam information, time zone restrictions, construction information, and school zones.

Step S206(1): A case where the first information processing terminal 100 is the sender terminal and the second information processing terminal 200 is the receiver terminal will be described. The integrated map synchronization unit 124 of the first information processing terminal 100 adds the additional information received from the server apparatus 300 to the first map created using the first creation system S1. In this manner, the integrated map synchronization unit 124 of the first information processing terminal 100 creates an integrated map and displays it on the display apparatus 107. The integrated map synchronization unit 124 sends the integrated map to the second information processing terminal 200. The integrated map synchronization unit 224 of the second information processing terminal 200 receives the integrated map. The integrated map synchronization unit 224 displays the received integrated map on the display apparatus 207. Accordingly, the map obtained by adding the additional information to the first map is displayed by synchronization (mirroring) between the display apparatus 107 and the display apparatus 207 as an integrated map (map obtained by integrating the first map and the second map). On the other hand, the integrated route synchronization unit 125 of the first information processing terminal 100 changes the first route created by the first generation unit 121 using the first creation system S1 on the basis of the additional information (e.g., makes a detour on the basis of incident information). In this manner, the integrated route synchronization unit 125 of the first information processing terminal 100 creates an integrated route and displays it on the display apparatus 107. The integrated route synchronization unit 125 sends the integrated route to the second information processing terminal 200. The integrated route synchronization unit 225 of the second information processing terminal 200 receives the integrated route. The integrated route synchronization unit 225 displays the received integrated route on the display apparatus 207, superimposed on the integrated map. Accordingly, the route obtained by changing the first route on the basis of the additional information is displayed by synchronization (mirroring) between the display apparatus 107 and the display apparatus 207 as an integrated route (route obtained by integrating the first route and the second route).

Step S206(2): A case where the second information processing terminal 200 is the sender terminal and the first information processing terminal 100 is the receiver terminal will be described. The integrated map synchronization unit 224 of the second information processing terminal 200 adds the additional information received from the server apparatus 300 to the second map created using the second creation system S2. In this manner, the integrated map synchronization unit 224 of the second information processing terminal 200 creates an integrated map and displays it on the display apparatus 207. The integrated map synchronization unit 224 sends the integrated map to the first information processing terminal 100. The integrated map synchronization unit 124 of the first information processing terminal 100 receives the integrated map. The integrated map synchronization unit 124 displays the received integrated map on the display apparatus 107. Accordingly, the map obtained by adding the additional information to the second map is displayed by synchronization (mirroring) between the display apparatus 107 and the display apparatus 207 as an integrated map (map obtained by integrating the first map and the second map). On the other hand, the integrated route synchronization unit 225 of the second information processing terminal 200 changes the second route created by the second generation unit 221 using the second creation system S2 on the basis of the additional information (e.g., makes a detour on the basis of incident information). In this manner, the integrated route synchronization unit 225 of the second information processing terminal 200 creates an integrated route and displays it on the display apparatus 207. The integrated route synchronization unit 225 sends the integrated route to the first information processing terminal 100. The integrated route synchronization unit 125 of the first information processing terminal 100 receives the integrated route. The integrated route synchronization unit 125 displays the received integrated route on the display apparatus 107, superimposed on the integrated map. Accordingly, the route obtained by changing the second route on the basis of the additional information is displayed by synchronization (mirroring) between the display apparatus 107 and the display apparatus 207 as an integrated route (route obtained by integrating the first route and the second route).

As a modified example, only the route may be synchronized without synchronizing the map.

### III. Third Embodiment

1. Functional Configurations of Information Processing System

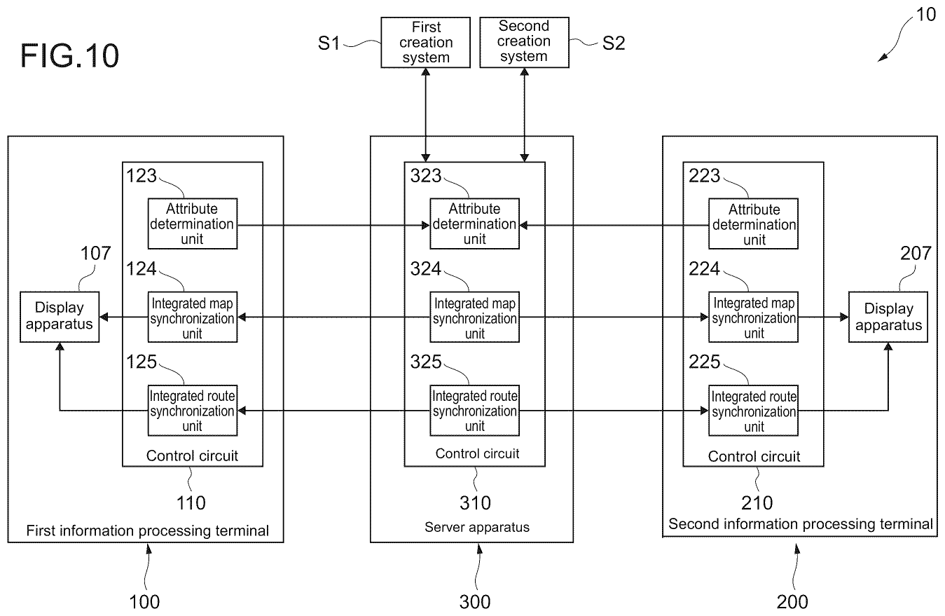

FIG. 10 shows functional configurations of an information processing system according to a third embodiment of the present disclosure.

In the control circuit 110 of the first information processing terminal 100, the CPU 111 loads the information processing program stored in the ROM 112 to the RAM 113 and executes it. In this manner, the CPU 111 operates as an attribute determination unit 123, an integrated map synchronization unit 124, and an integrated route synchronization unit 125.

In the control circuit 210 of the second information processing terminal 200, the CPU 211 loads the information processing program stored in the ROM 212 to the RAM 213 and executes it. In this manner, the CPU 211 operates as an attribute determination unit 223, an integrated map synchronization unit 224, and an integrated route synchronization unit 225.

In the control circuit 310 of the server apparatus 300, the CPU 311 loads the information processing program stored in the ROM 312 to the RAM 313 and executes it. In this manner, the CPU 311 operates as an attribute determination unit 323, an integrated map synchronization unit 324, and an integrated route synchronization unit 325.

2. Operation Flow of Information Processing System

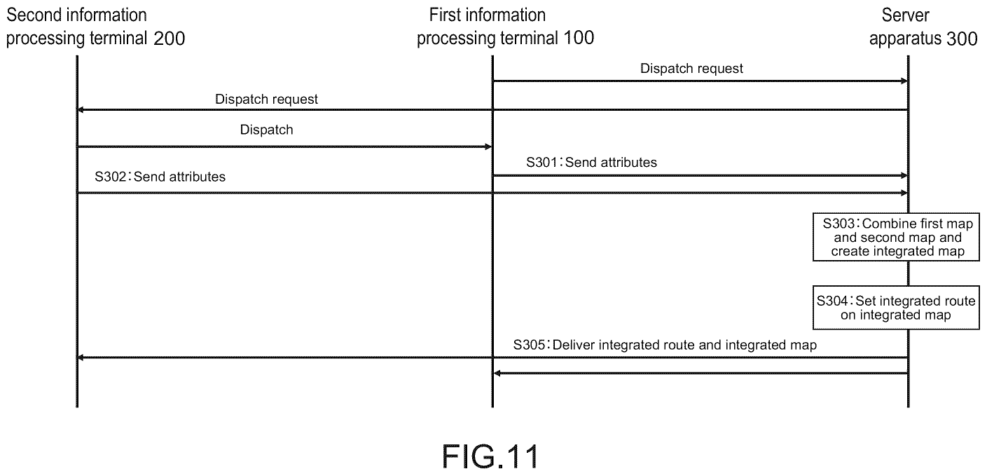

FIG. 11 shows an operation flow of the information processing system.

Step S301: The attribute determination unit 123 of the first information processing terminal 100 sends the attributes (supplier, version, etc.) of the first creation system S1 to the server apparatus 300. The attribute determination unit 323 of the server apparatus 300 receives the attributes of the first creation system S1 from the first information processing terminal 100.

Step S302: The attribute determination unit 223 of the second information processing terminal 200 sends the attributes (supplier, version, etc.) of the second creation system S2 to the server apparatus 300. The attribute determination unit 323 of the server apparatus 300 receives the attributes of the second creation system S2 from the second information processing terminal 200.

Step S303: The integrated map synchronization unit 324 of the server apparatus 300 creates a first map by using the first creation system S1 identified based on the received attributes and creates the second map by using the second creation system S2 identified based on the received attributes. The integrated map synchronization unit 324 creates an integrated map different from both the first map and the second map by combining the created first map and second map. In addition, the integrated map synchronization unit 324 may use a map created by adding additional information to the created integrated map, as an integrated map.

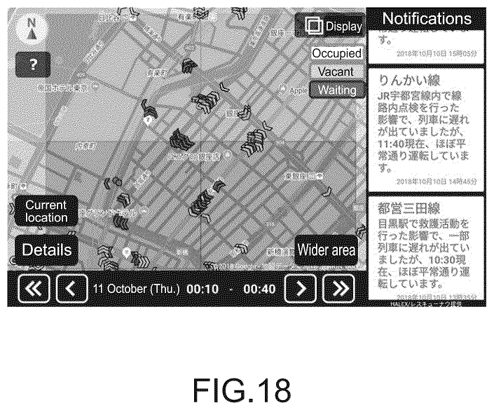

FIG. 18 shows an example of the integrated map. The integrated map is different from both the first map (FIG. 16) and the second map (FIG. 17).

Step S304: The integrated route synchronization unit 325 of the server apparatus 300 compares the attributes of the first creation system S1 of the first information processing terminal 100 with the attributes of the second creation system S2 of the second information processing terminal 200. The attribute determination unit 323 selects either one of the first creation system S1 and the second creation system S2 on the basis of a comparison result of the attributes. The integrated route synchronization unit 325 creates an integrated route (first route or second route) by using the selected one of the first creation system S1 and the second creation system S2. The integrated route synchronization unit 325 may further use a route created by changing the created integrated route on the basis of additional information (e.g., incident information), as an integrated route.

Step S305: The integrated map synchronization unit 324 of the server apparatus 300 sends the created integrated map to the first information processing terminal 100 and the second information processing terminal 200. The integrated route synchronization unit 325 of the server apparatus 300 sends the created integrated route to the first information processing terminal 100 and the second information processing terminal 200. The integrated map synchronization unit 124 of the first information processing terminal 100 receives the integrated map and displays it on the display apparatus 107. The integrated route synchronization unit 125 receives the integrated route and displays it on the display apparatus 107, superimposed on the integrated map. On the other hand, the integrated map synchronization unit 224 of the second information processing terminal 200 receives the integrated map and displays it on the display apparatus 207. The integrated route synchronization unit 225 receives the integrated route and displays it on the display apparatus 207, superimposed on the integrated map. Accordingly, the integrated map and the integrated route are displayed by synchronization (mirroring) between the display apparatus 107 and the display apparatus 207.

### IV. Fourth Embodiment

A fourth embodiment relates to an operation after the first information processing terminal 100 and the second information processing terminal 200 synchronize the integrated map and the integrated route (first to third embodiments) and to configurations for realizing this operation.

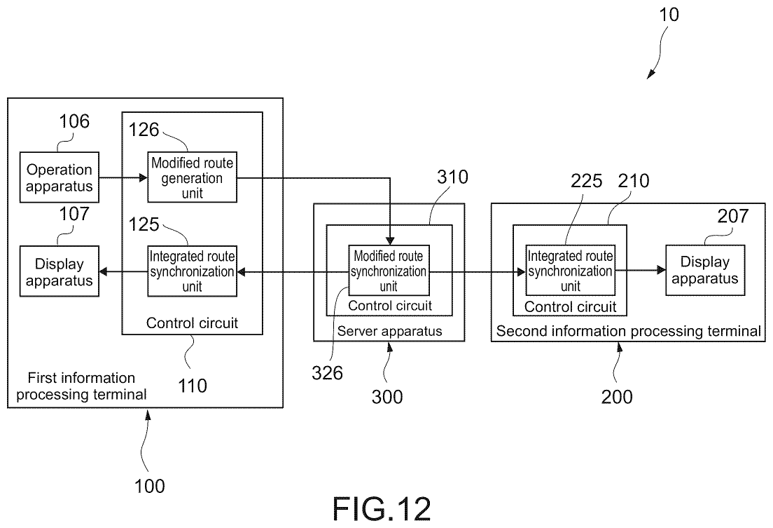

1. Functional Configurations of Information Processing System FIG. 12 shows functional configurations of an information processing system according to the fourth embodiment of the present disclosure.

In the control circuit 110 of the first information processing terminal 100, the CPU 111 loads the information processing program stored in the ROM 112 to the RAM 113 and executes it. In this manner, the CPU 111 operates as an integrated route synchronization unit 125 and a modified route generation unit 126.

In the control circuit 210 of the second information processing terminal 200, the CPU 211 loads the information processing program stored in the ROM 212 to the RAM 213 and executes it. In this manner, the CPU 211 operates as an integrated route synchronization unit 225.

In the control circuit 310 of the server apparatus 300, the CPU 311 loads the information processing program stored in the ROM 312 to the RAM 313 and executes it. In this manner, the CPU 311 operates as a modified route synchronization unit 326.

2. Operation Flow of Information Processing System

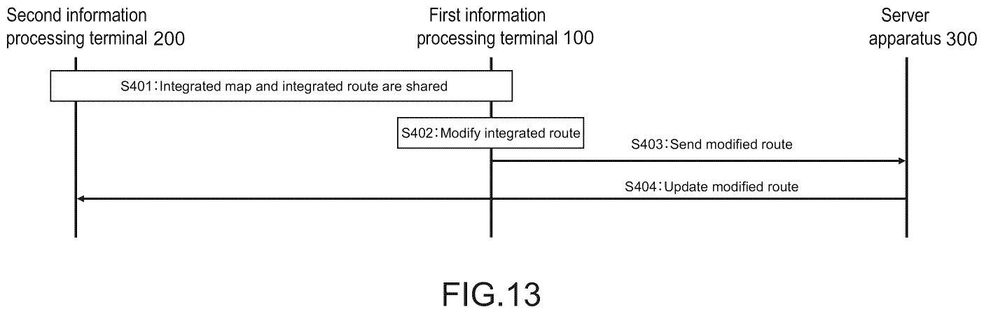

FIG. 13 shows an operation flow of the information processing system.

Step S401: The first information processing terminal 100 and the second information processing terminal 200 synchronize and display the integrated map and the integrated route (first to third embodiments).

Step S402: The passenger operates the integrated route (e.g., sliding on a desired route on a road-by-road basis or moving the displayed integrated route by drag and drop on a road-by-road basis) via the operation apparatus 106 (touch panel) in order to modify the integrated route displayed on the display apparatus 107 of the first information processing terminal 100. The modified route generation unit 126 of the first information processing terminal 100 creates a modified route that is a route obtained by modifying the integrated route on the basis of the operation input via the operation apparatus 106 (touch panel).

Step S403: The modified route generation unit 126 of the first information processing terminal 100 sends the created modified route to the server apparatus 300. The modified route synchronization unit 326 of the server apparatus 300 receives the modified route from the first information processing terminal 100. The modified route synchronization unit 326 changes the modified route on the basis of additional information. The modified route synchronization unit 326 changes the modified route if there is another route for arriving at the destination in a shorter time than the modified route, for example, due to the occurrence of an incident on the modified route desired by the passenger.

Step S404: The modified route synchronization unit 326 of the server apparatus 300 sends the modified route (and a reason in a case where the modified route is changed on the basis of the additional information) to the first information processing terminal 100 and the second information processing terminal 200. The integrated route synchronization unit 125 of the first information processing terminal 100 receives the modified route and displays it on the display apparatus 107, superimposed on the integrated map. On the other hand, the integrated route synchronization unit 225 of the second information processing terminal 200 receives the modified route and displays it on the display apparatus 207, superimposed on the integrated map. Accordingly, the modified route is displayed by synchronization (mirroring) between the display apparatus 107 and the display apparatus 207.

### V. Fifth Embodiment

A fifth embodiment relates to an operation after the first information processing terminal 100 and the second information processing terminal 200 synchronize the integrated map and the integrated route (first to third embodiments) and to configurations for realizing this operation.

1. Functional Configurations of Information Processing System

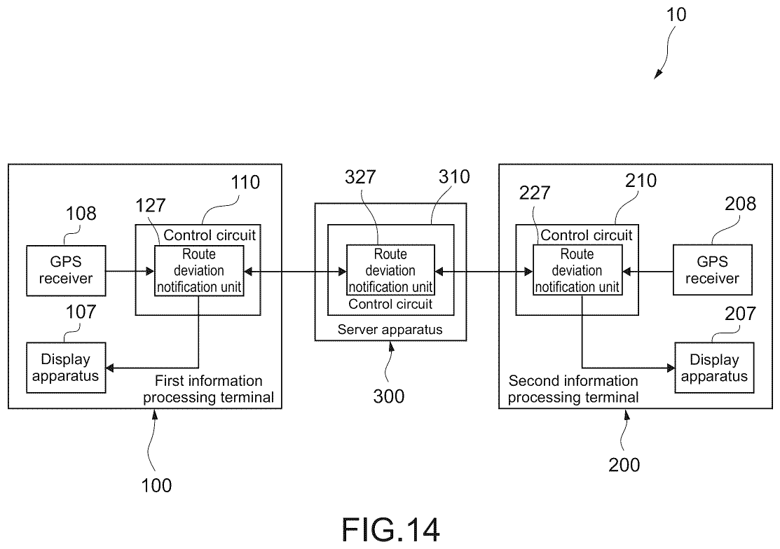

FIG. 14 shows functional configurations of an information processing system according to the fifth embodiment of the present disclosure.

In the control circuit 110 of the first information processing terminal 100, the CPU 111 loads the information processing program stored in the ROM 112 to the RAM 113 and executes it. In this manner, the CPU 111 operates as a route deviation notification unit 127.

In the control circuit 210 of the second information processing terminal 200, the CPU 211 loads the information processing program stored in the ROM 212 to the RAM 213 and executes it. In this manner, the CPU 211 operates as a route deviation notification unit 227.

In the control circuit 310 of the server apparatus 300, the CPU 311 loads the information processing program stored in the ROM 312 to the RAM 313 and executes it. In this manner, the CPU 311 operates as a route deviation notification unit 327.

2. Operation Flow of Information Processing System

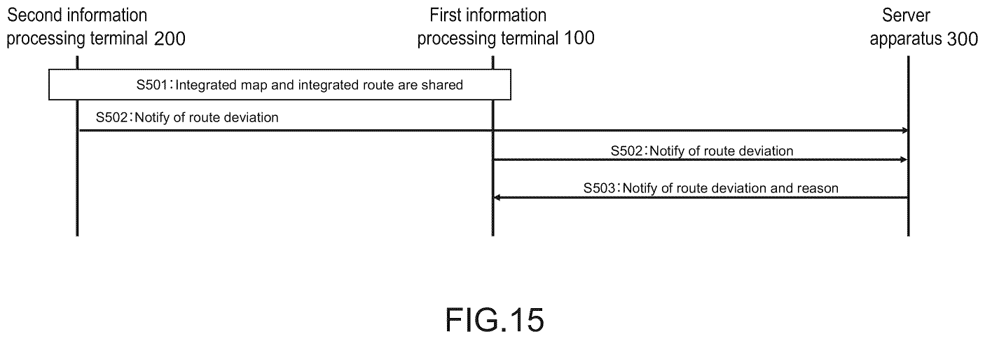

FIG. 15 shows an operation flow of the information processing system.

Step S501: The first information processing terminal 100 and the second information processing terminal 200 synchronize and display the integrated map and the integrated route (first to third embodiments).

Step S502: The route deviation notification unit 127 of the first information processing terminal 100 determines that the current location of the first information processing terminal 100 acquired via a GPS receiver 108 has deviated from the integrated route displayed on the display apparatus 107, and then notifies the server apparatus 300 the apparatus of it. The route deviation notification unit 227 of the second information processing terminal 200 determines the current location of the second information processing terminal 200 (corresponding to the current location of the first information processing terminal 100) acquired via a GPS receiver 208 has deviated from the integrated route displayed on the display apparatus 207, and then notifies the server apparatus 300 the apparatus of it. At least either one of the first information processing terminal 100 and the second information processing terminal 200 only needs to send this notification.

Step S503: The route deviation notification unit 327 of the server apparatus 300 determines on the basis of the notification that the current location of the first information processing terminal 100 or the second information processing terminal 200 has deviated from the integrated route. The route deviation notification unit 327 determines a reason of the deviation (e.g., making a detour around the scene of an incident, a traffic jam, a one-way road, or a narrow road) on the basis of additional information. The route deviation notification unit 327 of the server apparatus 300 outputs (sends) a notification indicating the deviation (reroute) (including the reason) to the first information processing terminal 100. The route deviation notification unit 127 of the first information processing terminal 100 displays on the display apparatus 107 the received notification indicating the deviation (including the reason). This enables the passenger to know the reason of the deviation. The route deviation notification unit 327 of the server apparatus 300 may further output (send) the notification indicating the deviation (including the reason) to the second information processing terminal 200 and the route deviation notification unit 227 of the second information processing terminal 200 may display on the display apparatus 207 the received notification indicating the deviation (including the reason).

### VI. Example of Previous Phase of Each Embodiment

1. Configuration Example of Taxi Dispatch System

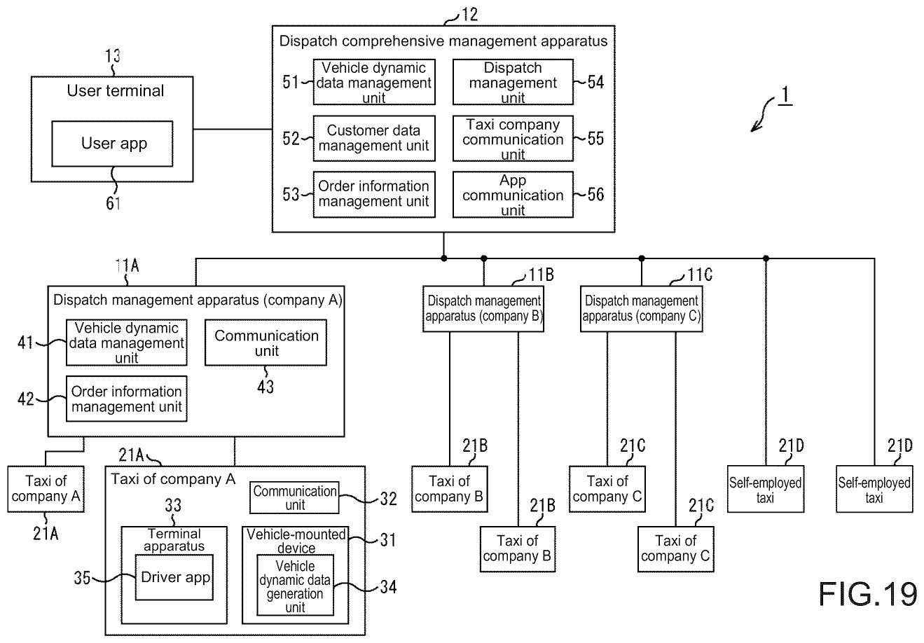

FIG. 19 is a block diagram showing a configuration example of a taxi dispatch system that is an example of the previous phase of each embodiment.

A taxi dispatch system 1 (corresponding to the information processing system 10 according to each embodiment) in FIG. 19 is a system that dispatches a taxi to a user on the basis of a request from the user. Here, the taxi is a movement apparatus and the user is a taxi user (corresponding to a passenger according to each embodiment). The taxi dispatch system 1 includes dispatch management apparatuses 11A to 11C and a dispatch comprehensive management apparatus 12 (corresponding to the server apparatus 300 according to each embodiment). The dispatch management apparatuses 11A to 11C belong to respective taxi companies such as a company A, a company B, and a company C. The dispatch comprehensive management apparatus 12 is a dispatch management apparatus that comprehensively manage them.

The dispatch management apparatus 11A of the company A is connected to one or more taxis 21A belonging to the company A via a predetermined network and also connected to the dispatch comprehensive management apparatus 12 via a predetermined network.

Similarly, the dispatch management apparatus 11B of the company B is connected to one or more taxis 21B belonging to the company B via a predetermined network and also connected to the dispatch comprehensive management apparatus 12 via a predetermined network.

Similarly, the dispatch management apparatus 11C of the company C is connected to one or more taxis 21C belonging to the company C via a predetermined network and also connected to the dispatch comprehensive management apparatus 12 via a predetermined network.

Moreover, a self-employed taxi 21D not belonging to any company is connected to the dispatch comprehensive management apparatus 12 via a predetermined network directly without using the dispatch management apparatus 11. The respective taxis 21A to 21C of the company A, the company B, and the company C and the self-employed taxi 21D will be simply referred to as taxis 21 when they are not especially distinguished.

Here, the predetermined network can include communication networks and communication channels compatible with any communication standards. Examples of the communication networks and communication channels include the Internet, a public switched telephone network, a wide area communication network for mobile communication such as so-called fourth-generation (4G) wireless network and fifth-generation (5G) wireless network, a wide area network (WAN), a local area network (LAN), a wireless communication network for communication compatible with Bluetooth (registered trademark) standards, a near-field communication channel for near field communication (NFC), a communication channel for infrared communication, and a communication network for wired communication compatible with standards such as a high-definition multimedia interface (HDMI (registered trademark)) and a universal serial bus (USB).

The taxi 21A of the company A includes a vehicle-mounted device 31 and a communication unit 32. Moreover, a terminal apparatus 33 (corresponding to the second information processing terminal 200 according to each embodiment) is mounted on the taxi 21A of the company A.

The vehicle-mounted device 31 includes a vehicle dynamic data generation unit 34. The vehicle dynamic data generation unit 34 acquires necessary data from a taximeter, a global positioning system (GPS) receiver, a gyro sensor, and a speedometer, and the like (all are not shown) and generates vehicle dynamic data. The vehicle dynamic data represents a dynamic log of the taxi 21A (vehicle).

The vehicle dynamic data generation unit 34 acquires from the taximeter, for example, data about statuses such as “occupied”, “vacant”, and “reserved”, fare, and the like. The status represents sales status of the taxi 21. Moreover, the vehicle dynamic data generation unit 34 acquires from the GPS receiver, the gyro sensor, and the speedometer, for example, information about a current location, a movement speed, a movement direction, and the like of the taxi 21A.

Then, the vehicle dynamic data generation unit 34 regularly or irregularly generates vehicle dynamic data and sends it to the dispatch management apparatus 11A of the company A via the communication unit 32. The vehicle dynamic data is information about a company ID for identifying the company to which the taxi 21A belongs, a wireless ID for identifying the vehicle that is the taxi 21A, a driver ID for identifying the driver of the taxi 21A (corresponding to the driver according to each embodiment), a status time representing a generation time of the status, latitude and longitude that is position information of the taxi 21A, travelling speed and travelling direction of the taxi 21A, the status of “occupied”, “vacant”, or “reserved”, and starting point and destination of the taxi 21 when the status is “occupied” or “reserved”, and the like.

The communication unit 32 sends the vehicle dynamic data generated by the vehicle dynamic data generation unit 34 of the vehicle-mounted device 31 to the dispatch management apparatus 11A of the company A. The communication unit 32 includes a network interface for network communication via a predetermined network.

The terminal apparatus 33 includes an information processing apparatus, for example, a smartphone or tablet terminal. A driver application (app) 35 that is an application program for a driver is mounted on the terminal apparatus 33. The driver app 35 acquires data about a dispatch request from the dispatch comprehensive management apparatus 12 and displays it on the display and sends data about a response to the dispatch request to the dispatch comprehensive management apparatus 12 on the basis of an operation of the driver. The driver app 35 communicates with the dispatch comprehensive management apparatus 12 directly via a network such as a wide-area communication network for mobile communication. It should be noted that the driver app 35 may communicate with the dispatch comprehensive management apparatus 12 through the dispatch management apparatus 11A of the company A via the communication unit 32.

The taxi 21B of the company B and the taxi 21C of the company C are basically similar to the taxi 21A of the company A, excluding the fact that they are different companies. Therefore, the descriptions will be omitted.

The dispatch management apparatus 11A of the company A collects vehicle dynamic data of taxis 21A of the one or more companies A and sends it to the dispatch comprehensive management apparatus 12. Moreover, the dispatch management apparatus 11A of the company A relays data about a dispatch request sent to the taxi 21A of the company A from the dispatch comprehensive management apparatus 12 and sends it to the specified taxi 21A of the company A.

The dispatch management apparatus 11A of the company A has a vehicle dynamic data management unit 41, an order information management unit 42, and a communication unit 43. The dispatch management apparatus 11A of the company A includes a server apparatus (information processing apparatus) having a network connection function, for example.

The vehicle dynamic data management unit 41 manages vehicle dynamic data respectively supplied from the taxis 21A of the company A. Specifically, the vehicle dynamic data management unit 41 stores the vehicle dynamic data respectively supplied from the taxis 21A of the company A in an internal storage unit and causes a display (not shown) to display the dynamic data of each taxi 21A. Moreover, the vehicle dynamic data management unit 41 sends the vehicle dynamic data supplied from each taxi 21A to the dispatch comprehensive management apparatus 12.

For example, when the company A receives a dispatch request call, an operator who manages the operation of the taxi 21A of the company A is able to check the current location of each taxi 21A of the company A and the status of “occupied” or “vacant” for example, which are stored in the vehicle dynamic data management unit 41, search for a taxi 21A that can respond the dispatch request, and allocate it.

The order information management unit 42 manages information about previous dispatch requests (dispatch reservations) from customers and the like. For example, when the operator of the taxi 21A of the company A receives a dispatch reservation call from a customer, the operator inputs the information about the dispatch reservation, for example, information about a reserved place, a reserved time, a customer name, a destination, and the like, to the order information management unit 42 from an operation terminal. The order information management unit 42 stores the information about the dispatch reservation. The order information management unit 42 displays the dispatch request a predetermined time before the reservation time. The operator who checks the display of the dispatch request makes a dispatch request to a predetermined taxi 21A on the basis of the vehicle dynamic data stored in the vehicle dynamic data management unit 41. It should be noted that the order information management unit 42 may search for an optimal taxi 21A and make a dispatch request on the basis of the vehicle dynamic data of the vehicle dynamic data management unit 41 a predetermined time before the reservation time.

The communication unit 43 performs predetermined communication with the dispatch comprehensive management apparatus 12 and each taxi 21A of the company A. For example, the communication unit 43 sends the dispatch request from the dispatch comprehensive management apparatus 12 to the predetermined taxi 21A or sends the vehicle dynamic data regularly acquired from each taxi 21A to the dispatch comprehensive management apparatus 12.

The dispatch management apparatuses 11B and 11C of the respective taxi companies such as the company B and the company C are also basically similar to the dispatch management apparatus 11A of the company A, excluding the fact that they are different companies. Therefore, the descriptions will be omitted. It should be noted that the respective dispatch management apparatuses 11A to 11C of the company A, the company B, and the company C will be simply referred to as dispatch management apparatuses 11 when they are not especially distinguished.

The dispatch comprehensive management apparatus 12 sends and receives vehicle dynamic data and data about dispatch requests and the like to/from the dispatch management apparatuses 11 of the company A, the company B, and the company C. Moreover, the dispatch comprehensive management apparatus 12 also communicates with an application program (hereinafter, referred to as user app) 61 via a predetermined network. The application program is for performing dispatch request mounted on a terminal apparatus (hereinafter, referred to as user terminal) 13 (corresponding to the first information processing terminal 100 according to each embodiment) of a user who is a taxi user. The dispatch comprehensive management apparatus 12 includes a server apparatus having a network connection function, for example.

The dispatch comprehensive management apparatus 12 is a dispatch management apparatus that manages the dispatch of all the taxis 21. The dispatch comprehensive management apparatus 12 has a vehicle dynamic data management unit 51, a customer data management unit 52, an order information management unit 53, a dispatch management unit 54, a taxi company communication unit 55, and an app communication unit 56.

The vehicle dynamic data management unit 51 manages vehicle dynamic data supplied from the dispatch management apparatus 11 of each taxi company and each self-employed taxi 21D. Specifically, the vehicle dynamic data management unit 51 stores vehicle dynamic data supplied from the dispatch management apparatus 11 of each taxi company and each self-employed taxi 21D in the internal storage unit and causes the display (not shown) of the vehicle dynamic data to display it. The vehicle dynamic data is information about the company ID of the taxi 21, the wireless ID of the taxi 21, the driver ID, the status time, the position information of the taxi 21, the travelling speed and the travelling direction of the taxi 21, the status, and the starting point and the destination of the taxi 21 when the status is “occupied” or “reserved”, and the like. Moreover, the vehicle dynamic data management unit 51 records the company ID of the taxi 21, the wireless ID of the taxi 21, the driver ID, the starting point and the destination, the fare, and the like in the internal storage unit as past occupation data every time when the status of “occupied” ends once.

The customer data management unit 52 generates customer data and stores it in the internal storage unit on the basis of data input by the operator or sent from the user app 61. For example, the customer data management unit 52 stores information about the customer's name, a taxi company that the customer likes, a taxi company that the customer wishes to send a taxi preferentially, a taxi stand that the customer often uses, an average waiting time for a reservation, and the like as the customer data with a customer ID that is identification information for identifying the customer. The customer data may be data input (specified) by the user in the user app 61 or may be data generated by the customer data management unit 52 on the basis of the user's ride history and the like.

The order information management unit 53 manages information about a previous dispatch request (dispatch reservation) from the customer or the like. While the order information management unit 42 of each dispatch management apparatus 11 manages information about the dispatch request (dispatch reservation) received by each taxi company, the order information management unit 53 manages information about the dispatch request (dispatch reservation) received by a representative reservation center that comprehensively controls each taxi company or the user app 61. The order information management unit 53 performs dispatch request to the dispatch management unit 54 a predetermined time before the reservation time of the dispatch reservation.

The dispatch management unit 54 controls dispatch based on the dispatch request or dispatch reservation. For example, when receiving a dispatch request from the user app 61, the dispatch management unit 54 extracts a taxi 21 that satisfies conditions of the dispatch request and sends a dispatch request on the basis of the vehicle dynamic data stored in the vehicle dynamic data management unit 51. Moreover, when receiving a dispatch request from the order information management unit 53, the dispatch management unit 54 extracts a taxi 21 that satisfies conditions of the dispatch request and sends a dispatch request to the driver app 35 on the basis of the vehicle dynamic data stored in the vehicle dynamic data management unit 51.

The taxi company communication unit 55 performs predetermined communication with each dispatch management apparatus 11 of the respective taxi companies. For example, the taxi company communication unit 55 receives the vehicle dynamic data regularly sent from each taxi 21 and supplies it to the vehicle dynamic data management unit 51 and sends the dispatch request from the dispatch management unit 54 to the predetermined taxi 21 via the dispatch management apparatus 11.

It should be noted that the taxi company communication unit 55 may receive vehicle dynamic data and send a dispatch request from the dispatch management unit 54 to the predetermined taxi 21 by communicating with the taxi 21 of each taxi company directly without using the dispatch management apparatus 11 of each taxi company.

The app communication unit 56 performs predetermined communication with the user app 61. For example, the app communication unit 56 receives the dispatch request from the user app 61 and supplies it to the dispatch management unit 54 or sends a dispatch determination notification to the user app 61 when the dispatch of the predetermined taxi 21 is determined.

It should be noted that although FIG. 19 only shows the user terminal 13 and the user app 61 corresponding to the single user for the sake of easy understanding, the dispatch comprehensive management apparatus 12 is capable of desired communication with the user app 61 of a plurality of user terminals 13 depending on needs.

The user terminal 13 includes an information processing apparatus that is a smartphone or tablet terminal for example, and performs predetermined communication with the dispatch comprehensive management apparatus 12. The user app 61 requests the dispatch comprehensive management apparatus 12 to dispatch the taxi 21 on the basis of an operation made by the user and displays dispatch determination responding to the dispatch request. Moreover, the user app 61 can also cause the display to display a current operation status and the like of the taxi 21 by acquiring vehicle dynamic data near the current location of the user from the dispatch comprehensive management apparatus 12.

In the taxi dispatch system 1 configured in the above-mentioned manner, when the user makes a dispatch request for the taxi 21 by operating the user app 61, the dispatch comprehensive management apparatus 12 refers to the vehicle dynamic data of the vehicle dynamic data management unit 51, searches for an optimal taxi 21, and sends a dispatch request to the found taxi 21.

Here, when searching for an optimal taxi 21, the dispatch comprehensive management apparatus 12 is capable of searching for not only taxis 21 whose status at the time of searching is “vacant” but also taxis 21 whose status is “occupied” or “reserved”.

This enables the user to get the taxi 21 in a shorter waiting time because taxis 21 that can accept the dispatch request increase. Moreover, it can lower the possibility that a vacant taxi cannot be found in a case where particular time zone, place, weather, or the like increases the demand for taxis.

Moreover, it enables the driver of the taxi 21 to reduce the time to pick up the next passenger after the occupied status in which the passenger is in the taxi and to reduce the time and movement to pick up the next passenger.

The taxi dispatch system 1 can thus achieve efficient dispatch.

2. Flow of Entire Taxi Dispatch System

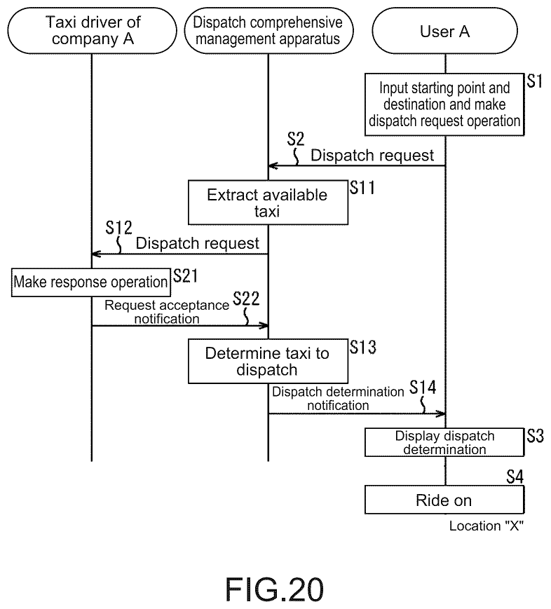

First of all, referring to the flowchart of FIG. 20, a flow of processing of the entire taxi dispatch system 1 will be described and details of a process of each of the dispatch comprehensive management apparatus 12, the taxi 21, and the user terminal 13 will be described.

FIG. 20 is a flowchart of dispatch control processing by a taxi dispatch system.

This processing assumes a situation where a user A gets in the taxi 21A of the company A by using the user app 61, and the taxi 21A occupied by the user A is allocated when a user B requests to dispatch the taxi 21 by using the user app 61 while the user A is in the taxi 21A.

It should be noted that processing in which the dispatch comprehensive management apparatus 12 regularly or irregularly acquires vehicle dynamic data of the taxi 21 from each taxi 21 and updates the vehicle dynamic data of the vehicle dynamic data management unit 51 is performed constantly in addition to the processing of FIG. 20.

First of all, in Step S1, the user A inputs a starting point “X” and a destination “Y” to the user app 61 and performs a dispatch request operation.

In Step S2, the user app 61 of the user A sends to the dispatch comprehensive management apparatus 12 the dispatch request with information about the starting point “X” and the destination “Y”.

In Step S11, the dispatch management unit 54 of the dispatch comprehensive management apparatus 12 receives the dispatch request from the user app 61 of the user A and extracts an available taxi 21 by referring to current vehicle dynamic data managed by the vehicle dynamic data management unit 51. Here, a taxi 21A of the company A that is a taxi 21 nearest the starting point “X” and having the status of “vacant” is found.

In Step S12, the dispatch management unit 54 sends a dispatch request to the found taxi 21A of the company A.

In Step S21, the driver app 35 of the taxi 21A of the company A acquires data about the dispatch request (e.g., the starting point “X” and the destination “Y”) from the dispatch comprehensive management apparatus 12 and displays it on the display. Then, the driver performs an operation to accept the dispatch request. Then, in Step S22, the driver app 35 sends a request acceptance notification to accept the dispatch request to the dispatch comprehensive management apparatus 12.

The dispatch management unit 54 of the dispatch comprehensive management apparatus 12 receives the request acceptance notification from the taxi 21A in Step S13. Then, the dispatch management unit 54 of the dispatch comprehensive management apparatus 12 determines that taxi 21A as a taxi to dispatch. In Step S14, the dispatch management unit 54 of the dispatch comprehensive management apparatus 12 sends a dispatch determination notification to the driver app 35 of the user A.

The driver app 35 of the user A receives the dispatch determination notification from the dispatch comprehensive management apparatus 12 in Step S3. Then, the driver app 35 performs dispatch determination display indicating that the dispatch is determined. Then, the taxi 21A of the company A allocated to the user A arrives at the starting point “X” in Step S4. Then, the user A gets in the taxi 21A and starts to move to the destination “Y”.

### VII. Conclusions

Some passengers need to specify their own favorite routes to taxi drivers or ride-sharing drivers. However, a map displayed on an information terminal apparatus used by a driver and a map displayed on an information terminal apparatus used by a passenger are often different. Differences in creation system and version used by the respective information terminal apparatuses cause a differences in amount of information and performance. The difference in creation system can also cause a difference between a route displayed on the information terminal apparatus used by the driver and a route displayed on the information terminal apparatus used by the passenger even with the same destination. Moreover, a difference in taxi company also causes a difference in route displayed on the information terminal apparatus used by the driver. It is sometimes difficult for the passenger to give an appropriate instruction about the route directly to a taxi driver or ride-sharing driver in a case where the route displayed on the information terminal apparatus used by the driver is different from the route displayed on the information terminal apparatus used by the passenger.

In this regard, in accordance with the present embodiment, the information processing system displays an integrated map, synchronized between the first display apparatus 107 of the first information processing terminal 100 used by the passenger and the second display apparatus 207 of the second information processing terminal 200 used by the driver, the integrated map being a map obtained by integrating the first map created by the first information processing terminal 100 used by the passenger and the second map created by the second information processing terminal 100 used by the driver. Further, the information processing system 10 displays an integrated route, synchronized between the first display apparatus 107 and the second display apparatus 207, the integrated route being a route obtained by integrating the first route and the second route.

In accordance with the present embodiment, in a case where the first map created by the first information processing terminal 100 used by the passenger is different from the second map created by the second information processing terminal 200 used by the driver, a common integrated map is displayed on the first information processing terminal 100 and the second information processing terminal 200. In other words, the passenger and the driver uses a common integrated map on a road-by-road basis. Therefore, the passenger and the driver can reliably share information on a road-by-road basis, preventing the possibility that one map has a narrow path that the other map does not have. In accordance with the present embodiment, in a case where the first route created by the first information processing terminal 100 used by the passenger is different from the second route created by the second information processing terminal 200 used by the driver, a common integrated route is displayed on the first information processing terminal 100 and the second information processing terminal 200. In other words, the passenger and the driver use a common integrated route on a road-by-road basis. Therefore, the passenger easily instructs the driver about a desired route on a road-by-road basis.

The first information processing terminal 100 creates a modified route, which is a route obtained by modifying the integrated route, by operating the integrated route displayed on the first display apparatus 107 via the operation apparatus 106. The server apparatus 300 displays the modified route, synchronized between the first display apparatus 107 and the second display apparatus 207.

In accordance with the present embodiment, the passenger and the driver use a common integrated map on a road-by-road basis. Therefore, a modified route desired by the passenger can be reliably displayed on the second information processing terminal 200 used by the driver, preventing the possibility that one map has a narrow path that the other map does not have, for example.

The server apparatus 300 changes the modified route created by the first information processing terminal 100 on the basis of the additional information and displays the changed modified route, synchronized between the first display apparatus 107 and the second display apparatus 207.

In accordance with the present embodiment, the server apparatus 300 changes the modified route desired by the passenger on the basis of the additional information (e.g., avoids the scene of an incident) rather than employing the modified route desired by the passenger as it is. This can present a more suitable modified route.

The integrated map is the first map or the second map created using either one of the first creation system S1 and the second creation system S2, which is selected on the basis of the attributes.

In accordance with the present embodiment, the creation system selected on the basis of the attributes (suppliers, versions, etc.) creates the integrated map. Therefore, the passenger and the driver can share a more advanced integrated map.

The integrated map is created by adding the additional information to the integrated map.

In accordance with the present embodiment, a change is made on the basis of the additional information rather than employing the first map or the second map as the integrated map as it is. This enables the passenger and the driver to share the additional information (e.g., incident information). Therefore, the passenger and the driver can easily communicate with each other, for example, easily change the route on the basis of common recognition.

Either one of the first information processing terminal 100 and the second information processing terminal 200 creates the integrated map and sends the created integrated map to the other of the first information processing terminal 100 and the second information processing terminal 200.

In accordance with the present embodiment, the integrated map created by the one information processing terminal can be directly synchronized (mirrored) with the other information processing terminal.

The integrated map is created by combining the first map and the second map and is different from both the first map and the second map.

In accordance with the present embodiment, the first map and the second map are combined rather than employing the first map or the second map as the integrated map as it is. This enables the passenger and the driver to share an integrated map including higher-level information. Moreover, since the integrated map includes both elements of the first map and the second map, the integrated map includes map elements familiar to both the passenger and the driver. It is user-friendly.

The integrated map is created by adding the additional information to the integrated map.

In accordance with the present embodiment, the integrated map obtained by combining the first map and the second map is changed on the basis of the additional information rather than employing it as the integrated map as it is. This enables the passenger and the driver to share the additional information (e.g., incident information). Therefore, the passenger and the driver can easily communicate with each other, for example, easily change the route on the basis of common recognition.

The server apparatus 300 creates the integrated map and sends the created integrated map to the first information processing terminal 100 and the second information processing terminal 200.

In accordance with the present embodiment, the integrated map created by the one information processing terminal can be synchronized (mirrored) with the other information processing terminal via the server apparatus 300.

The integrated route is the first route or the second route created using either one of the first creation system S1 and the second creation system S2, which is selected on the basis of the attributes.

In accordance with the present embodiment, the creation system selected on the basis of the attributes (suppliers, versions, etc.) creates the integrated map. Therefore, the passenger and the driver can share a more appropriate (e.g., faster) integrated route.

The integrated route is created by changing the integrated route on the basis of the additional information.

In accordance with the present embodiment, the first route or the second route is changed on the basis of the additional information rather than employing it as the integrated route as it is. This enables the passenger and the driver to share the additional information (e.g., incident information). Therefore, the passenger and the driver can share a more appropriate (e.g., faster) integrated route.

The either one of the first information processing terminal 100 and the second information processing terminal 200 creates the integrated route and sends the created integrated route to the other one of the first information processing terminal 100 and the second information processing terminal 200.

In accordance with the present embodiment, the integrated route created by the one information processing terminal can be directly synchronized (mirrored) with the other information processing terminal.

The server apparatus 300 creates the integrated route and sends the created integrated route to the first information processing terminal 100 and the second information processing terminal 200.

In accordance with the present embodiment, the integrated route created by the one information processing terminal can be synchronized (mirrored) with the other information processing terminal via the server apparatus 300.

The information processing system 10 determines that the current location of the first information processing terminal 100 or the second information processing terminal 200 has deviated from the integrated route, and then outputs the notification indicating the deviation to the first information processing terminal 100.

In accordance with the present embodiment, the passenger can know the deviation of the route and the reason by using the first information processing terminal 100.

The present disclosure can have the following configurations.

(1) An information processing system, including:
a first information processing terminal that includes a first display apparatus and is configured to display on the first display apparatus a first map and a first route from a current location to a destination in a superimposed manner, the first map being created using a first creation system;
a second information processing terminal that is capable of communicating with the first information processing terminal, includes a second display apparatus, and is configured to display on the second display apparatus a second map and a second route from the current location to the destination in a superimposed manner, the second map being created by a second creation system;
an integrated map synchronization unit that displays an integrated map, synchronized between the first display apparatus and the second display apparatus, the integrated map being a map obtained by integrating the first map and the second map; and
an integrated route synchronization unit that displays an integrated route, synchronized between the first display apparatus and the second display apparatus, the integrated route being a route obtained by integrating the first route and the second route.

(2) The information processing system according to (1), in which
the first information processing terminal includes
   an operation apparatus, and
   a modified route generation unit that operates the integrated route displayed on the first display apparatus via the operation apparatus, thereby creating a modified route, the modified route being a route obtained by modifying the integrated route, further including
a server apparatus that is capable of communicating with the first information processing terminal and the second information processing terminal and has a modified route synchronization unit that displays the modified route, synchronized between the first display apparatus and the second display apparatus.

(3) The information processing system according to (2), in which
the modified route synchronization unit of the server apparatus changes the modified route created by the modified route generation unit of the first information processing terminal on the basis of additional information and displays the changed modified route, synchronized between the first display apparatus and the second display apparatus, the first creation system and the second creation system not having the additional information.

(4) The information processing system according to any one of (1) to (3), in which
the integrated map is the first map or the second map created using either one of the first creation system and the second creation system, which is selected on the basis of an attribute.

(5) The information processing system according to (4), in which
the integrated map is created by adding additional information to the integrated map, the first creation system and the second creation system not having the additional information.

(6) The information processing system according to any one of (1) to (5), in which
the first information processing terminal and the second information processing terminal each include the integrated map synchronization unit, and
the integrated map synchronization unit of either one of the first information processing terminal and the second information processing terminal creates the integrated map and sends the created integrated map to another one of the first information processing terminal and the second information processing terminal.

(7) The information processing system according to (1) to (6), in which
the integrated map is created by combining the first map and the second map and is different from both the first map and the second map.

(8) The information processing system according to (7), in which
the integrated map is created by adding additional information to the integrated map, the first creation system and the second creation system not having the additional information.

(9) The information processing system according to any one of (1) to (5), further including
a server apparatus that is capable of communicating with the first information processing terminal and the second information processing terminal and has the integrated map synchronization unit, in which
the integrated map synchronization unit creates the integrated map and sends the created integrated map to the first information processing terminal and the second information processing terminal.

(10) The information processing system according to any one of (1) to (9), in which
the integrated route is the first route or the second route created using either one of the first creation system and the second creation system, which is selected on the basis of an attribute.

(11) The information processing system according to (10), in which
the integrated route is created by changing the integrated route on the basis of additional information, which the first creation system and the second creation system do not have.

(12) The information processing system according to (10) or (11), in which
the first information processing terminal and the second information processing terminal each include the integrated route synchronization unit, and
the integrated route synchronization unit of either one of the first information processing terminal and the second information processing terminal creates the integrated route and sends the created integrated route to another one of the first information processing terminal and the second information processing terminal.

(13) The information processing system according to (10) or (11), further including
a server apparatus that is capable of communicating with the first information processing terminal and the second information processing terminal and has the integrated route synchronization unit, in which
the integrated route synchronization unit creates the integrated route and sends the created integrated route to the first information processing terminal and the second information processing terminal.

(14) The information processing system according to any one of (1) to (13), further including
a route deviation notification unit that determines that a current location of the first information processing terminal or the second information processing terminal has deviated from the integrated route and outputs a notification indicating the deviation to the first information processing terminal.

(15) The information processing system according to any one of (1) to (14), in which
the first information processing terminal is used by a passenger who travels from the current location to the destination by the vehicle, and
the second information processing terminal is used by a driver of the vehicle.

(16) An information processing method, including:
by an information processing system including,
a first information processing terminal that includes a first display apparatus and is configured to display on the first display apparatus a first map and a first route from a current location to a destination in a superimposed manner, the first map being created using a first creation system, and
a second information processing terminal that is capable of communicating with the first information processing terminal, includes a second display apparatus, and is configured to display on the second display apparatus a second map and a second route from the current location to the destination in a superimposed manner, the second map being created by a second creation system,
displaying an integrated map, synchronized between the first display apparatus and the second display apparatus, the integrated map being a map obtained by integrating the first map and the second map; and
displaying an integrated route, synchronized between the first display apparatus and the second display apparatus, the integrated route being a route obtained by integrating the first route and the second route.

(17) An information processing program that causes
a processor of
a first information processing terminal that includes a first display apparatus and is configured to display on the first display apparatus a first map and a first route from a current location to a destination in a superimposed manner, the first map being created using a first creation system, or
a second information processing terminal that is capable of communicating with the first information processing terminal, includes a second display apparatus, and is configured to display on the second display apparatus a second map and a second route from the current location to the destination in a superimposed manner, the second map being created by a second creation system, to operate to:
display an integrated map, synchronized between the first display apparatus and the second display apparatus, the integrated map being a map obtained by integrating the first map and the second map; and
display an integrated route, synchronized between the first display apparatus and the second display apparatus, the integrated route being a route obtained by integrating the first route and the second route.

(18) A non-transitory computer-readable recording medium recording an information processing program that causes
a processor of
a first information processing terminal that includes a first display apparatus and is configured to display on the first display apparatus a first map and a first route from a current location to a destination in a superimposed manner, the first map being created using a first creation system, or
a second information processing terminal that is capable of communicating with the first information processing terminal, includes a second display apparatus, and is configured to display on the second display apparatus a second map and a second route from the current location to the destination in a superimposed manner, the second map being created by a second creation system, to operate to:
display an integrated map, synchronized between the first display apparatus and the second display apparatus, the integrated map being a map obtained by integrating the first map and the second map; and
display an integrated route, synchronized between the first display apparatus and the second display apparatus, the integrated route being a route obtained by integrating the first route and the second route.

Although the embodiments and modified examples of the present technology are described hereinabove, it should be understood that the present technology is not limited to those embodiments and various modifications can be made without departing from the gist of the present technology.

### REFERENCE SIGNS LIST

10 information processing system
100 first information processing terminal
121 first generation unit
122 near-field communication connection unit
123 attribute determination unit
124 integrated map synchronization unit
125 integrated route synchronization unit
126 modified route generation unit
127 route deviation notification unit
200 second information processing terminal
221 second generation unit
222 near-field communication connection unit
223 attribute determination unit
224 integrated map synchronization unit
225 integrated route synchronization unit
227 route deviation notification unit
300 server apparatus
323 attribute determination unit
324 integrated map synchronization unit
325 integrated route synchronization unit
326 modified route synchronization unit
327 route deviation notification unit

1. An information processing system, comprising:
a first information processing terminal that includes a first display apparatus and is configured to display on the first display apparatus a first map and a first route from a current location to a destination in a superimposed manner, the first map being created using a first creation system;
a second information processing terminal that is capable of communicating with the first information processing terminal, includes a second display apparatus, and is configured to display on the second display apparatus a second map and a second route from the current location to the destination in a superimposed manner, the second map being created by a second creation system;
an integrated map synchronization unit that displays an integrated map, synchronized between the first display apparatus and the second display apparatus, the integrated map being a map obtained by integrating the first map and the second map; and
an integrated route synchronization unit that displays an integrated route, synchronized between the first display apparatus and the second display apparatus, the integrated route being a route obtained by integrating the first route and the second route.

2. The information processing system according to claim 1, wherein
the first information processing terminal includes
an operation apparatus, and
a modified route generation unit that operates the integrated route displayed on the first display apparatus via the operation apparatus, thereby creating a modified route, the modified route being a route obtained by modifying the integrated route, further comprising
a server apparatus that is capable of communicating with the first information processing terminal and the second information processing terminal and has a modified route synchronization unit that displays the modified route, synchronized between the first display apparatus and the second display apparatus.

3. The information processing system according to claim 2, wherein
the modified route synchronization unit of the server apparatus changes the modified route created by the modified route generation unit of the first information processing terminal on a basis of additional information and displays the changed modified route, synchronized between the first display apparatus and the second display apparatus, the first creation system and the second creation system not having the additional information.

4. The information processing system according to claim 1, wherein
the integrated map is the first map or the second map created using either one of the first creation system and the second creation system, which is selected on a basis of an attribute.

5. The information processing system according to claim 4, wherein
the integrated map is created by adding additional information to the integrated map, the first creation system and the second creation system not having the additional information.

6. The information processing system according to claim 1, wherein
the first information processing terminal and the second information processing terminal each include the integrated map synchronization unit, and
the integrated map synchronization unit of either one of the first information processing terminal and the second information processing terminal creates the integrated map and sends the created integrated map to another one of the first information processing terminal and the second information processing terminal.

7. The information processing system according to claim 1, wherein
the integrated map is created by combining the first map and the second map and is different from both the first map and the second map.

8. The information processing system according to claim 7, wherein
the integrated map is created by adding additional information to the integrated map, the first creation system and the second creation system not having the additional information.

9. The information processing system according to claim 7, further comprising
a server apparatus that is capable of communicating with the first information processing terminal and the second information processing terminal and has the integrated map synchronization unit, wherein
the integrated map synchronization unit creates the integrated map and sends the created integrated map to the first information processing terminal and the second information processing terminal.

10. The information processing system according to claim 1, wherein
the integrated route is the first route or the second route created using either one of the first creation system and the second creation system, which is selected on a basis of an attribute.

11. The information processing system according to claim 10, wherein
the integrated route is created by changing the integrated route on a basis of additional information, which the first creation system and the second creation system do not have.

12. The information processing system according to claim 10, wherein
the first information processing terminal and the second information processing terminal each include the integrated route synchronization unit, and
the integrated route synchronization unit of either one of the first information processing terminal and the second information processing terminal creates the integrated route and sends the created integrated route to another one of the first information processing terminal and the second information processing terminal.

13. The information processing system according to claim 10, further comprising
a server apparatus that is capable of communicating with the first information processing terminal and the second information processing terminal and has the integrated route synchronization unit, wherein
the integrated route synchronization unit creates the integrated route and sends the created integrated route to the first information processing terminal and the second information processing terminal.

14. The information processing system according to claim 1, further comprising
a route deviation notification unit that determines that a current location of the first information processing terminal or the second information processing terminal has deviated from the integrated route and outputs a notification indicating the deviation to the first information processing terminal.

15. The information processing system according to claim 1, wherein
the first information processing terminal is used by a passenger who travels from the current location to the destination by the vehicle, and
the second information processing terminal is used by a driver of the vehicle.

16. An information processing method, comprising:
by an information processing system including,
a first information processing terminal that includes a first display apparatus and is configured to display on the first display apparatus a first map and a first route from a current location to a destination in a superimposed manner, the first map being created using a first creation system, and
a second information processing terminal that is capable of communicating with the first information processing terminal, includes a second display apparatus, and is configured to display on the second display apparatus a second map and a second route from the current location to the destination in a superimposed manner, the second map being created by a second creation system,
displaying an integrated map, synchronized between the first display apparatus and the second display apparatus, the integrated map being a map obtained by integrating the first map and the second map; and
displaying an integrated route, synchronized between the first display apparatus and the second display apparatus, the integrated route being a route obtained by integrating the first route and the second route.

17. An information processing program that causes
a processor of
a first information processing terminal that includes a first display apparatus and is configured to display on the first display apparatus a first map and a first route from a current location to a destination in a superimposed manner, the first map being created using a first creation system, or
a second information processing terminal that is capable of communicating with the first information processing terminal, includes a second display apparatus, and is configured to display on the second display apparatus a second map and a second route from the current location to the destination in a superimposed manner, the second map being created by a second creation system, to operate to:
display an integrated map, synchronized between the first display apparatus and the second display apparatus, the integrated map being a map obtained by integrating the first map and the second map; and
display an integrated route, synchronized between the first display apparatus and the second display apparatus, the integrated route being a route obtained by integrating the first route and the second route.
